(19) United States
(12) Patent Application Publication
(10) Pub. No.: US 2020/0276825 A1
(43) Pub. Date: Sep. 3, 2020

(54) LIQUID CONTAINER

(71) Applicant: SEIKO EPSON CORPORATION, Tokyo (JP)

(72) Inventors: Yoshiaki SHIMIZU, Matsumoto-shi (JP); Ryoichi TANAKA, Shiojiri-shi (JP); Taku ISHIZAWA, Matsumoto-shi (JP); Tadahiro MIZUTANI, Shiojiri-shi (JP)

(73) Assignee: SEIKO EPSON CORPORATION, Tokyo (JP)

(21) Appl. No.: 16/803,601

(22) Filed: Feb. 27, 2020

(30) Foreign Application Priority Data
Feb. 28, 2019 (JP) 2019-036553

(51) Int. Cl. B41J 2/175

(52) U.S. Cl. CPC B41J 2/17553

(57) ABSTRACT

A liquid container including a liquid storing chamber that stores a liquid, a first member including a cylindrical first side wall surrounding at least a portion of the liquid storing chamber, a first opening surrounded by a first end portion of the first side wall, and a second opening surrounded by a second end portion of the first side wall, a liquid outlet member including an outlet through which the liquid flows out, the liquid outlet member being attached to the first opening, and a second member joined to the first member, the second member sealing the liquid storing chamber from a second opening side. When viewed in a central axis direction of the first member, a joint between the first member and the second member is formed outside an area surrounded by a boundary between the first member and the second member in the liquid storing chamber.

The present application is based on, and claims priority from JP Application Serial Number 2019-036553, filed Feb. 28, 2019, the disclosure of which is hereby incorporated by reference herein in its entirety.

### BACKGROUND

### 1. Technical Field

The present disclosure relates to a liquid container.

### 2. Related Art

There are liquid containers in which a liquid storing chamber that stores a liquid is formed by welding a plurality of members to each other. For example, in a liquid container disclosed in JP-A-2015-66750, resin members, which include opening portions through which a liquid flows out, are joined to two ends of a cylindrical resin sleeve portion by laser welding to form a liquid storing chamber therein.

As in the technique in JP-A-2015-66750, when a plurality of members are welded to each other by laser welding, one of the two members that are welded to each other needs to be configured of a material that transmits a laser beam and the other needs to be configured of a material that absorbs the laser beam. Accordingly, the degree of freedom in selecting the materials constituting the liquid container is limited, and a joining technique other than laser welding is not considered in JP-A-2015-66750.

It is desirable that a liquid container, in which a liquid storing chamber is formed by joining a plurality of members to each other, has a structure that allows a plurality of members to be easily joined to each other by, not limited to laser welding, various joining techniques.

### SUMMARY

A configuration in which the technique of the present disclosure has been implemented is provided as a liquid container. A liquid container of such a configuration includes a liquid storing chamber in which a liquid is stored, a first member that includes a cylindrical first side wall that surrounds at least a portion of the liquid storing chamber, a first opening surrounded by a first end portion of the first side wall, and a second opening surrounded by a second end portion of the first side wall, a liquid outlet member that includes an outlet through which the liquid flows out, the liquid outlet member being attached to the first opening, and a second member joined to the first member, the second member sealing the liquid storing chamber from a second opening side. When viewed in a central axis direction of the first member, a joint between the first member and the second member is formed outside an area surrounded by a boundary between the first member and the second member in the liquid storing chamber.

### BRIEF DESCRIPTION OF THE DRAWINGS

FIG. 1 is a schematic perspective view illustrating a configuration of a liquid consuming device.

FIG. 2 is a schematic perspective view illustrating an ink supplying unit.

FIG. 3 is a schematic plan view illustrating the ink supplying unit.

FIG. 4 is a partial and schematic cross-sectional view illustrating a lateral side of the ink tank.

FIG. 5 is a partial and schematic cross-sectional view illustrating a front side of the ink tank.

FIG. 6 is a schematic perspective view of a liquid container of a first exemplary embodiment.

FIG. 7 is a schematic side view of the liquid container of the first exemplary embodiment.

FIG. 8 is a schematic perspective view illustrating the liquid container in which a cap has been detached therefrom.

FIG. 9 is a schematic cross-sectional view of the liquid container of the first exemplary embodiment.

FIG. 10 is a schematic and exploded perspective view illustrating a state in which a valve member has been taken out from a liquid outlet member.

FIG. 11 is a first partially cross-sectioned side view illustrating a process of refilling ink into an ink tank.

FIG. 12 is a second partially cross-sectioned side view illustrating the process of refilling the ink into the ink tank.

FIG. 13 is a schematic cross-sectional view in which a peripheral portion of a joint between a first member and a second member has been extracted.

FIG. 14 is a schematic perspective view of a liquid container of a second exemplary embodiment.

FIG. 15 is a schematic side view of the liquid container of the second exemplary embodiment.

FIG. 16 is a schematic cross-sectional view of the liquid container of the second exemplary embodiment.

FIG. 17 is a schematic perspective view of a liquid container of a third exemplary embodiment.

FIG. 18 is a schematic side view of the liquid container of the third exemplary embodiment.

FIG. 19A is a schematic cross-sectional view of the liquid container of the third exemplary embodiment.

FIG. 19B is a schematic cross-sectional view in which a peripheral portion of a joint between a first member and a second member has been extracted.

FIG. 20 is a schematic perspective view of a liquid container of a fourth exemplary embodiment.

FIG. 21 is a schematic side view of the liquid container of the fourth exemplary embodiment.

FIG. 22A is a schematic cross-sectional view of the liquid container of the fourth exemplary embodiment.

FIG. 22B is a schematic cross-sectional view in which a peripheral portion of a joint between a first member and a second member has been extracted.

FIG. 23 is a schematic cross-sectional view of the liquid container of the fifth exemplary embodiment.

FIG. 24 is a schematic perspective view of a liquid container of a sixth exemplary embodiment.

FIG. 25 is a schematic side view of the liquid container of the sixth exemplary embodiment.

FIG. 26 is a schematic cross-sectional view of the liquid container of the sixth exemplary embodiment.

FIG. 27 is a schematic cross-sectional view of a liquid container of a seventh exemplary embodiment.

FIG. 28 is a schematic perspective view of a liquid container of an eighth exemplary embodiment.

FIG. 29 is a schematic side view of the liquid container of the eighth exemplary embodiment.

FIG. 30 is a schematic cross-sectional view of the liquid container of the eighth exemplary embodiment.

FIG. 31 is a schematic perspective view of a liquid container of a ninth exemplary embodiment.

FIG. 32 is a schematic side view of the liquid container of the ninth exemplary embodiment.

FIG. 33 is a schematic cross-sectional view of the liquid container of the ninth exemplary embodiment.

FIG. 34 is a schematic perspective view of a liquid container of a tenth exemplary embodiment.

FIG. 35 is a schematic side view of the liquid container of the tenth exemplary embodiment.

FIG. 36 is a schematic cross-sectional view of the liquid container of the tenth exemplary embodiment.

FIG. 37 is a schematic perspective view of a liquid container of an eleventh exemplary embodiment.

FIG. 38 is a schematic side view of the liquid container of the eleventh exemplary embodiment.

FIG. 39 is a schematic cross-sectional view of the liquid container of the eleventh exemplary embodiment.

### DESCRIPTION OF EXEMPLARY EMBODIMENTS

### 1. First Exemplary Embodiment

### 1-1. Liquid Consuming System

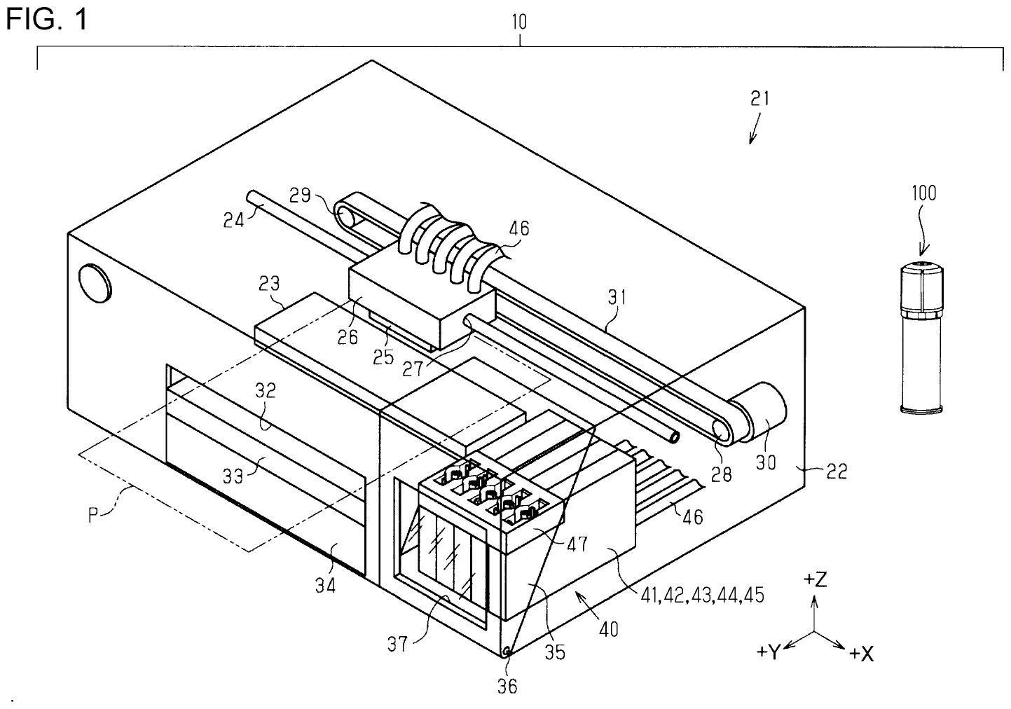

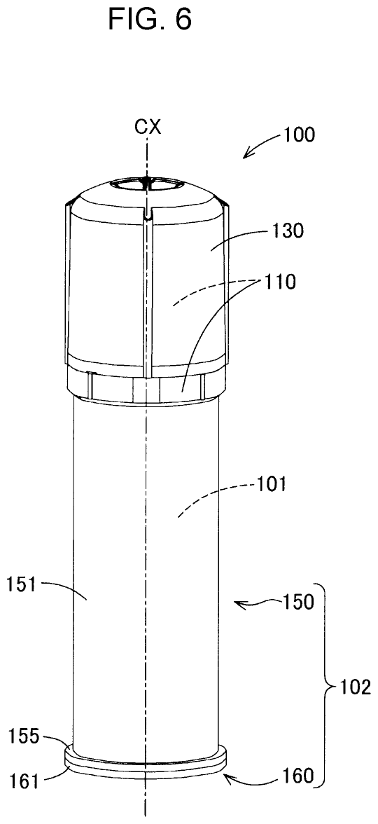

FIG. 1 is a schematic view illustrating an example of a liquid consuming system 10 including a liquid container 100 according to a first exemplary embodiment. In addition to the liquid container 100, the liquid consuming system 10 includes a liquid consuming device 21 that consumes a liquid. In the liquid consuming system 10, the user refills the liquid in the liquid container 100 into the liquid consuming device 21. Hereinafter, referring first to FIGS. 1 to 5, a configuration of the liquid consuming device 21 will be described, and referring to FIGS. 6 to 13, the liquid container 100 of the first exemplary embodiment will be described.

### 1-2. Liquid Consuming Device

FIG. 1 is a schematic perspective view schematically illustrating a configuration of the liquid consuming device 21. FIG. 1 illustrates the liquid consuming device 21 in a simplified manner while the components inside a housing 22 is seen through the housing 22. Furthermore, in FIG. 1, an X direction, a Y direction, and a Z direction that are orthogonal to each other are depicted so as to correspond to the liquid consuming device 21 disposed on a horizontal surface. The X direction and the Y direction are directions parallel to the horizontal direction, and the Z direction is a direction parallel to the vertical direction. The X direction matches the left-right direction of the liquid consuming device 21. In the X direction, a +X direction is the right direction when facing the front side of the liquid consuming device 21, and a −X direction is the left direction. The Y direction matches the front-rear direction of the liquid consuming device 21. In the Y direction, a +Y direction is the frontward direction, and a −Y direction is the rearward direction. The Z direction matches the up-down direction of the liquid consuming device 21. In the Z direction, a +Z direction is the upward direction and a −Z direction is the downward direction. The X direction, the Y direction, and the Z direction depicted in the drawings referred to later correspond to those in FIG. 1.

The liquid consuming device 21 is an ink jet printer that records an image and the like on a medium by ejecting ink, which is an example of the liquid, on the medium. The liquid consuming device 21 includes the housing 22 that has a rectangular parallelepiped shape in which the left-right direction is the longitudinal direction. A support base 23, the longitudinal direction thereof being the left-right direction, is provided in a lower rear portion inside the housing 22 so that an upper surface thereof extends in the left-right direction. A sheet of paper P, which is an example of the medium, is transported towards the front side, which is a transport direction, while the sheet of paper P is supported by the upper surface of the support base 23. A guide shaft 24 that extends in the left-right direction is provided at a position inside the housing 22 above the support base 23. A carriage 26 that includes, on an under surface side thereof, a recording head 25 that ejects ink is supported by the guide shaft 24. The guide shaft 24 is inserted through a support hole 27 that penetrates through the carriage 26 in the left-right direction. The carriage 26 is configured to reciprocate in the left-right direction relative to the guide shaft 24.

A driving pulley 28 and a driven pulley 29 are supported in a rotatable manner at positions inside the housing 22 near two ends of the guide shaft 24. An output shaft of a carriage motor 30 is coupled to the driving pulley 28. An endless timing belt 31, a portion of which is coupled to the carriage 26, is wound around the driving pulley 28 and the driven pulley 29. When the carriage 26 is reciprocated in the left-right direction, which is a direction in which scanning is performed on the sheet of paper P, through the timing belt 31 with the drive of the carriage motor 30 while being guided by the guide shaft 24, the ink is ejected onto the sheet of paper P, which is transported in the forward direction on the support base 23, from the recording head 25 on the under surface side of the carriage 26.

A rectangular discharge port 32 that discharges the sheet of paper P, on which recording has been performed by ejection of ink, towards the front side is open on a front surface side of the housing 22 at a position in front of the support base 23. A rectangular plate-shaped discharge tray 33 configured to support the sheet of paper P discharged from the housing 22 is provided in the discharge port 32. The discharge tray 33 can be pulled out towards the front side. A sheet feeding cassette 34 configured to store a plurality of sheets of paper P stacked on each other is mounted inside the discharge port 32 and below the discharge tray 33. The sheet feeding cassette 34 is detectable in the front-rear direction.

An opening/closing door 35 is provided in the front surface of the housing 22 and on an end portion side of the housing 22 in the left-right direction with respect to the discharge port 32. In FIG. 1, the opening/closing door 35 is provided on the right end portion side in the front surface of the housing 22. A front surface and an upper surface of the opening/closing door 35 have a rectangular shape and a right surface has a right-angle triangle shape. The opening/closing door 35 is opened/closed by being pivoted in the front-rear direction about a rotation shaft 36 that is provided at a lower end of the opening/closing door 35 and that extends in the left-right direction. A window portion 37 formed of a rectangular transparent member is formed in the front surface of the opening/closing door 35. The user can view the inside of the housing 22 when the opening/closing door 35 is in a closed state.

An ink supplying unit 40 that supplies the ink to the recording head 25 is housed inside the housing 22 of the liquid consuming device 21 and behind the opening/closing door 35. The ink supplying unit 40 includes a plurality of ink tanks 41 to 45. In the present exemplary embodiment, the ink supplying unit 40 includes five ink tanks 41 to 45. The ink supplying unit 40 is a structure allowing the ink tanks 41 to 45 to be managed integrally. The user refills the ink from the liquid container 100 to each of the ink tanks 41 to 45.

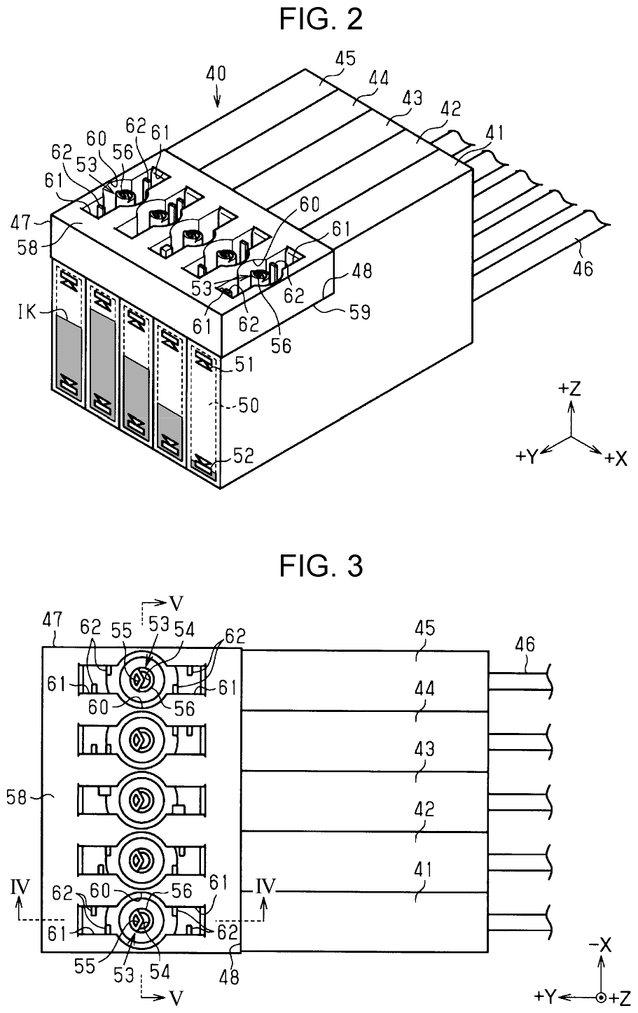

FIG. 2 is a schematic perspective view illustrating the ink supplying unit 40. FIG. 3 is a schematic plan view illustrating the ink supplying unit 40. The ink supplying unit 40 includes five ink tanks 41 to 45, five ink supply tubes 46 that extend out from rear surface sides of the ink tanks 41 to 45, and an ink refill adapter 47 that is mounted on the ink tanks 41 to 45 and that acts to couple the liquid container 100 to the ink tanks 41 to 45. Each of the ink tanks 41 to 45 is configured as a rectangular box in which the dimension in the left-right direction is the smallest. Each of the ink tanks 41 to 45 is coupled to the recording head 25 held in the carriage 26 illustrated in FIG. 1 through the corresponding ink supply tube 46.

Level different portions 48 to where the adapter 47 are attached are formed in the ink tanks 41 to 45. The level different portions 48 are rectangular cutaways in the upper front portions of the ink tanks 41 to 45. In the ink supplying unit 40, the ink tanks 41 to 45 are integrated and coupled to each other by having the adapter 47 having a rectangular parallelepiped shape be attached thereto while the ink tanks 41 to 45 are arranged in the left-right direction. As described later, when refilling the ink, the liquid container 100 is engaged and coupled to the adapter 47.

Note that the adapter 47 may be a member constituting a portion of the housing 22 that covers the ink tanks 41 to 45 or may be integrally formed with the ink tanks 41 to 45. Furthermore, the adapter 47 do not have to include a function of being coupled to the ink tanks 41 to 45 and may be divided so that each adapter is mounted on the corresponding one of the ink tanks 41 to 45.

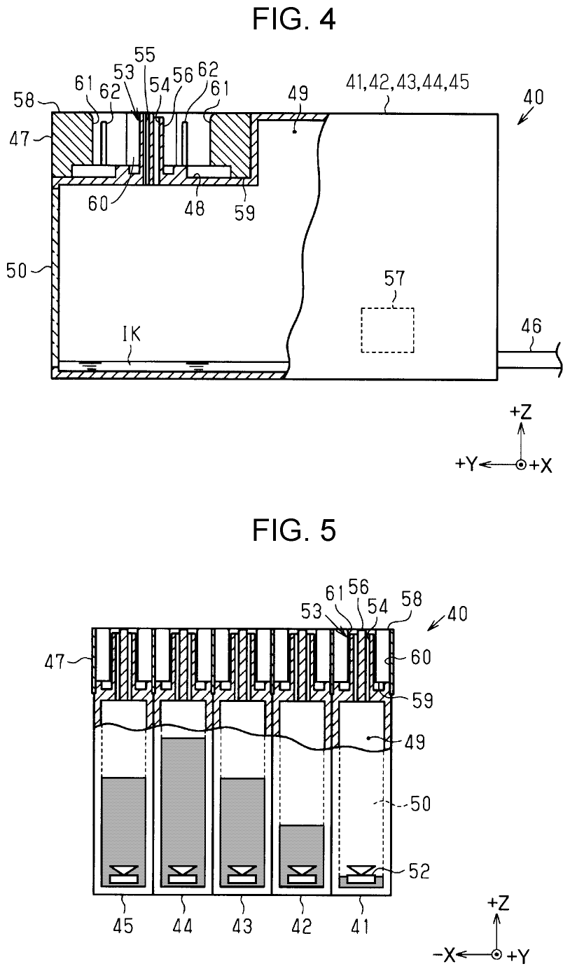

FIGS. 4 and 5 are schematic and partial cross-sectional views that partially include cross sections of the ink tanks 41 to 45 taken along line IV-IV and V-V in FIG. 3. FIG. 4 illustrates a lateral side of the ink tanks 41 to 45, and FIG. 5 illustrates a front side of the ink tanks 41 to 45.

Each ink tanks 41 to 45 includes an ink storage chamber 49 configured to store ink IK therein. Ink of different colors are stored in the ink tanks 41 to 45. For example, black ink is stored in the ink tank 41 at the right end, and the ink tanks 42 to 45 arranged on the left side of the ink tank 41 store colored ink other than black such as, for example, cyan, magenta, and yellow ink.

Viewing portions 50 that enable the user to view liquid levels of the ink IK inside the ink storage chambers 49 through the window portion 37 in the front surface of the housing 22 are provided in front wall portions of the ink tanks 41 to 45. The viewing portions 50 are configured of a transparent resin, for example. An upper limit mark 51 that indicates a reference for the upper limit of the liquid level of the ink IK stored in the ink storage chamber 49 and a lower limit mark 52 that indicates a reference for the lower limit are marked in each viewing portion 50. The reference indicated by the upper limit mark 51 is, for example, a reference indicting the amount of ink that can be filled through an ink receiving portion 53 without spilling the ink. The reference indicated by the lower limit mark 52 is, for example, a reference that encourages the user to refill the ink.

As illustrated in FIG. 4, the ink receiving portion 53 that allows the ink to flow into the ink storage chamber 49 from the outside is provided on the upper side of the horizontal portion of the level different portion 48 in each of the ink tanks 41 to 45. Each ink receiving portion 53 includes a needle-like ink port 56 that extends vertically upwards. Two parallel flow paths 54 and 55 that communicate the inside and the outside of the ink storage chamber 49 are provided inside each ink port 56. As illustrated in FIG. 3, the first flow paths 54 are provided behind the second flow paths 55. Sections of the openings of the first and second flow paths 54 and 55 have shapes in which a single circle is compartmented into two fan shapes with wall portions that extend radially from the center of the circle. The first flow path 54 is provided behind the second flow path 55 and a flow-path sectional area of the first flow path 54 is larger than that of the second flow path 55. Furthermore, as illustrated in FIG. 4, the first flow path 54 is formed so that a height of an opening at the distal end thereof is lower than a height of an opening at the distal end of the second flow path 55. A remaining amount sensor 57 that detects the amount of ink IK remaining inside the ink storage chamber 49 is provided at a rear lower portion inside each ink storage chamber 49. The remaining amount sensor 57 may be omitted.

As illustrated in FIG. 4, a through hole that penetrates the adapter 47 in the up-down direction from an upper surface 58 to an under surface 59 is formed in the adapter 47. As illustrated in FIGS. 2 and 3, the opening of the through hole has a shape in which a pair of substantially rectangular hole portions 61, the openings thereof each having a substantially rectangular section, are coupled to the front and the rear of a circular hole portion 60, the opening thereof having a substantially circular section. As illustrated in FIGS. 2 to 5, in the ink supplying unit 40, the ink port 56 of the ink receiving portion 53 included in each of the ink tanks 41 to 45 is disposed in the middle of the corresponding circular hole portion 60. As described later, when the ink is refilled into each of the ink tanks 41 to 45, a portion of a liquid outlet member 110 of the corresponding liquid container 100 is fitted into the circular hole portion 60 and the rectangular hole portions 61. Note that colors that are the same as the colored inks stored in the ink tanks 41 to 45 may be applied as references to the rims of the circular hole portions 60 and the rims of the rectangular hole portions 61 in the upper surface 58 of the adapter 47.

In the first exemplary embodiment, discrimination protrusions 62 that protrude from the inner lateral surface of the rectangular hole portion 61 are provided inside each of the rectangular hole portions 61 of the ink tanks 41 to 45 at different positions. As described above, a fitting groove portion 116 configured to fit the discrimination protrusion 62 of one of the ink tanks 41 to 45 that stores the colored ink that matches the colored ink of the liquid container 100 is provided in the liquid outlet member 110 of the liquid container 100. Since the discrimination protrusion 62 cannot be fitted to the fitting groove portion 116 of the liquid outlet member 110 of the liquid container 100 that stores the colored ink that does not match the colored ink thereof, the liquid outlet member 110 of the liquid container 100 is prevented from being fitted in the rectangular hole portions 61 of the adapter 47. Note that as illustrated in FIGS. 2 to 5, the discrimination protrusions 62 in the pair of rectangular hole portions 61 provided above each of the ink tanks 42 and 45 are provided in a point symmetrical manner with the center of the circular hole portion 60 as the point of symmetry. The reason for the above will be described later.

### 1-3. Configuration of Liquid Container

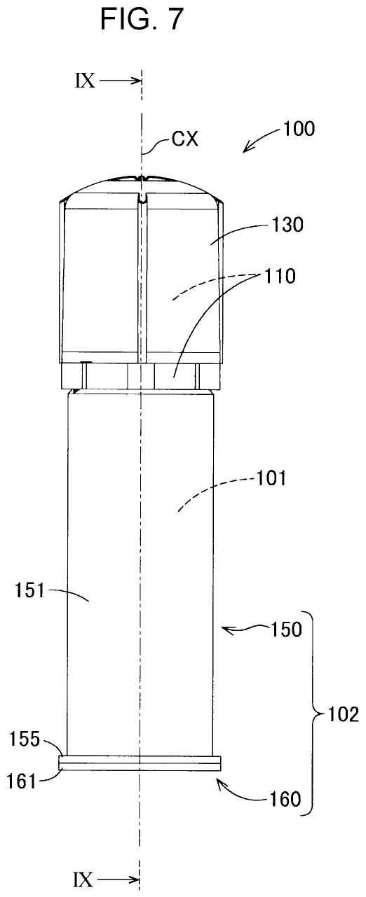

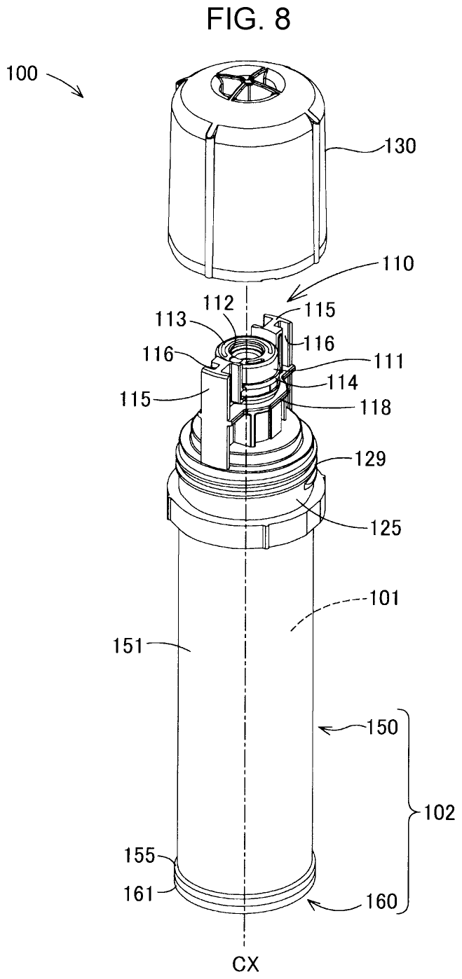

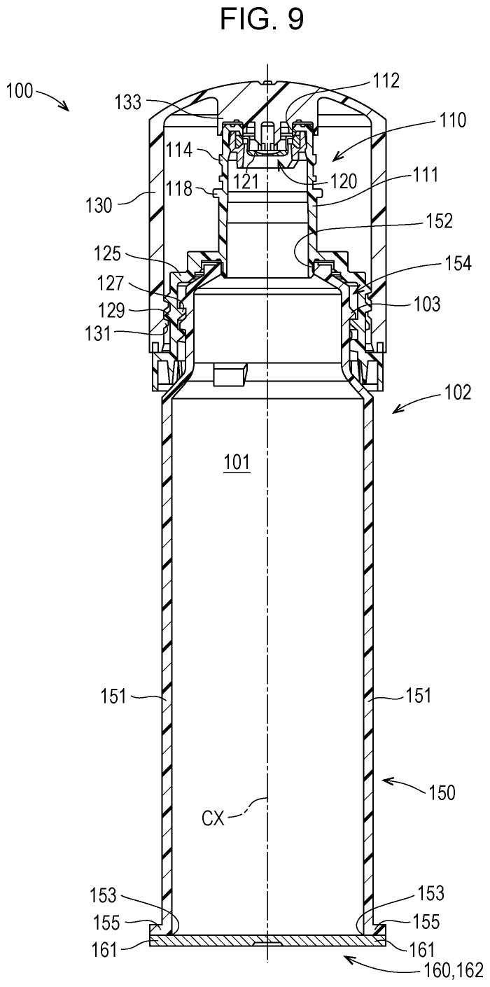

Referring to FIGS. 6 to 13, a configuration of the liquid container 100 according to the first exemplary embodiment will be described. FIG. 6 is a schematic perspective view illustrating a liquid container 100, and FIG. 7 is a schematic side view of the liquid container 100 and is a plan view of a lateral surface. FIGS. 6 and 7 illustrate a state in which a cap 130 is attached to the liquid container 100. FIG. 8 is a schematic perspective view illustrating a state in which the cap 130 has been detached from the liquid container 100. FIG. 9 is a schematic cross-sectional view of the liquid container 100 cut along IX-IX and through a central axis CX illustrated in FIG. 7. In the drawings, the central axis CX of the liquid container 100 is depicted by a dot and dash line. Note that a direction parallel to the central axis CX is, hereinafter, referred to as a “central axis direction”.

The liquid container 100 includes a liquid storing chamber 101 that is an internal space that stores a liquid. In the first exemplary embodiment, the liquid stored in the liquid container 100 is the ink refilled into the ink tanks 41 to 45 of the liquid consuming device 21 described above. The liquid container 100 includes a hollow container body 102, the liquid outlet member 110 attached to the container body 102, and the cap 130 attached to the liquid outlet member 110 in a detachable manner.

Hereinafter, a side of the liquid container 100 in the central axis direction on which the liquid outlet member 110 is provided is referred to as a “front end side”, and a side opposite to the front end side is referred to as a “rear end side”. An end portion of the liquid container 100 on the rear end side is formed flat and is configured to be placeable on a horizontal surface when the liquid container 100 is positioned so that the front end side is oriented upwards and the rear end side is oriented downwards.

### 1-3-1. Container Body

As illustrated in FIGS. 6 to 8, the container body 102 is configured of a hollow member having a columnar external shape. The container body 102 is fabricated with a resin material such as, for example, polypropylene (PP) or polyethylene terephthalate (PET). The container body 102 is fabricated by mounting a first member 150 on a second member 160 and joining the first member 150 and the second member 160 in the central axis direction. Detailed configurations of the first member 150 and the second member 160 and a joining method of the first member 150 and the second member 160 will be described later.

### 1-3-2. Liquid Outlet Member

Referring to FIG. 8, the liquid outlet member 110 is a member that functions as a so-called spout and is attached to an end portion of the liquid container 100 on the front end side. The liquid outlet member 110 is a cylindrical member and is fabricated by injection molding a resin material such as, for example, polypropylene or polyethylene terephthalate.

The liquid outlet member 110 includes, on the front end side thereof, a tubular pipe portion 111 that is configured to be in communication with the liquid storing chamber 101. In the first exemplary embodiment, the pipe portion 111 has a cylindrical shape extending along the central axis CX. The pipe portion 111 includes an outlet 112 in the end portion thereof on the front end side. The outlet 112 is an opening through which the liquid stored in the liquid storing chamber 101 flows out. In the first exemplary embodiment, the center of the outlet 112 is on the central axis CX of the liquid container 100. Furthermore, the pipe portion 111 has a diameter that fits into the circular hole portion 60 of the adapter 47 illustrated in FIG. 3.

A groove portion 113 is formed in an end surface of the pipe portion 111 on the front end side and along an external circumference of the outlet 112. By providing the groove portion 113, the ink adhered to the periphery of the outlet 112 after refilling the ink into one of the ink tanks 41 to 45 can be made to flow into the groove portion 113 and be stored before the ink drips to the lateral surface of the pipe portion 111. Accordingly, dripping of the ink adhered to the periphery of the outlet 112 to the lateral surface of the pipe portion 111 can be suppressed.

An annular protrusion 114 that protrudes in a radial direction of the pipe portion 111 and that is formed along an external circumference of the pipe portion 111 is provided on a lateral surface of the external circumference of the pipe portion 111. The annular protrusion 114 can stop the liquid that has spilt from the outlet 112 to the lateral surface of the pipe portion 111 from moving along the lateral surface of the pipe portion 111 and dripping to the rear end side. Note that in the present specification, the “radial direction” of the tubular or cylindrical member indicates a direction orthogonal to the central axis of the tubular or cylindrical member.

The liquid outlet member 110 further includes a pair of fitting portions 115 on two sides of the pipe portion 111 in the radial direction. Each of the pair of fitting portions 115 is configured to fit into the corresponding rectangular hole portion 61 of the adapter 47 illustrated in FIGS. 2 to 4. In the first exemplary embodiment, the fitting portions 115 are formed as rectangular columnar members extending along the pipe portion 111. The fitting groove portions 116 are provided along the pipe portion 111 and in lateral surfaces of the fitting portions 115. The fitting groove portions 116 are configured so that the discrimination protrusions 62 provided in the rectangular hole portions 61 illustrated in FIGS. 2 to 4 fit therein. Note that the pair of fitting portions 115 may be omitted.

The liquid outlet member 110 further includes a positioning portion 118 that extends out in the radial direction in the lateral surfaces of the pipe portion 111 and the fitting portions 115. The positioning portion 118 includes an upper surface that faces the front end side and that extends in the radial direction. As described later, when the liquid container 100 is coupled to the adapter 47, the upper surface of the positioning portion 118 abuts against the upper surface 58 of the adapter 47 at the peripheries of the circular hole portion 60 and the rectangular hole portions 61. With the above, the position of the liquid container 100 is set when the ink is refilled into one of the ink tanks 41 to 45.

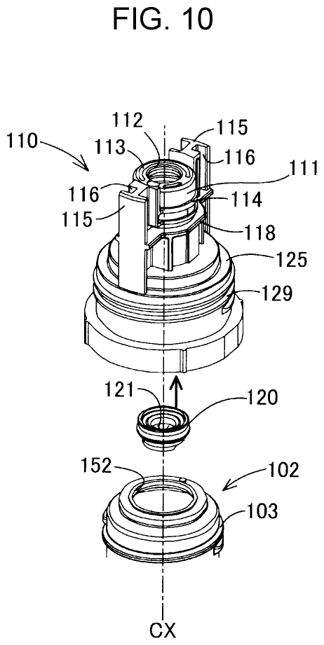

Referring to FIGS. 9 and 10, FIG. 10 is a schematic and exploded perspective view illustrating a state in which the liquid outlet member 110 has been detached from the container body 102 and in which a valve member 120 has been taken out from the inside of the liquid outlet member 110. The valve member 120 is a member that seals the outlet 112 of the liquid outlet member 110 in an openable/closable manner. The valve member 120 in the first exemplary embodiment is configured as a so-called slit valve. A body of the valve member 120 is configured of an elastic member such as a silicon film, and a slit 121 that is opened/closed by being deformed in the thickness direction is provided at the middle. As illustrated by an arrow in FIG. 10, the valve member 120 is inserted inside the liquid outlet member 110 from the rear end side and, as illustrated in FIG. 9, is attached to the front end of the pipe portion 111 so as to seal the outlet 112. The valve member 120 is fixed on the front end side with respect to the positioning portion 118.

Referring to FIGS. 8 and 9, the liquid outlet member 110 includes, on the rear end side with respect to the positioning portion 118, a connection portion 125 that fixes the liquid outlet member 110 to the container body 102. The connection portion 125 is configured as a cylindrical member having a diameter that is larger than that of the pipe portion 111. A female screw portion 127 that is screwed together with a male screw portion 103 provided in an external circumference of the container body 102 is provided in an internal circumferential surface of the connection portion 125. A male screw portion 129 that fixes the cap 130 to the liquid container 100 in a detachable manner is provided in an external circumferential surface of the connection portion 125.

### 1-3-3. Cap

Referring to FIGS. 6 to 9, the cap 130 is configured of a cylindrical member in which an end portion on the front end side is closed and on which another side is open. The cap 130 is fabricated by injection molding a resin material such as, for example, polypropylene or polyethylene terephthalate. The cap 130 accommodating the liquid outlet member 110 is attached to a front end side of the liquid container 100. A female screw portion 131 that is screwed together with the male screw portion 129 provided in the connection portion 125 of the liquid outlet member 110 described above is provided in an internal circumferential surface of the cap 130. As illustrated in FIG. 9, a closing portion 133 that closes the outlet 112 in a watertight manner is provided on an inner wall surface of the cap 130 and at a position opposing the outlet 112 of the liquid outlet member 110. “Watertight” may be rephrased as liquid tight. By attaching the cap 130, the liquid outlet member 110 is protected and leakage of ink from the outlet 112 is prevented.

### 1-3-4. Refilling Ink into Ink Tank

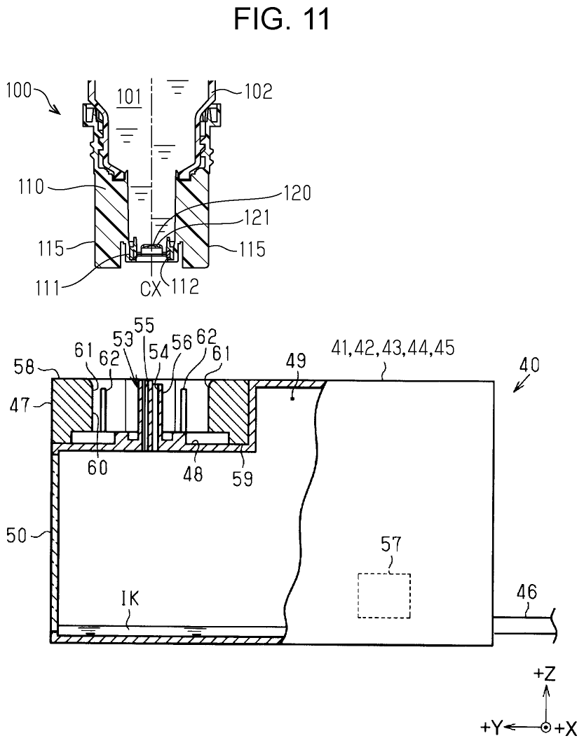

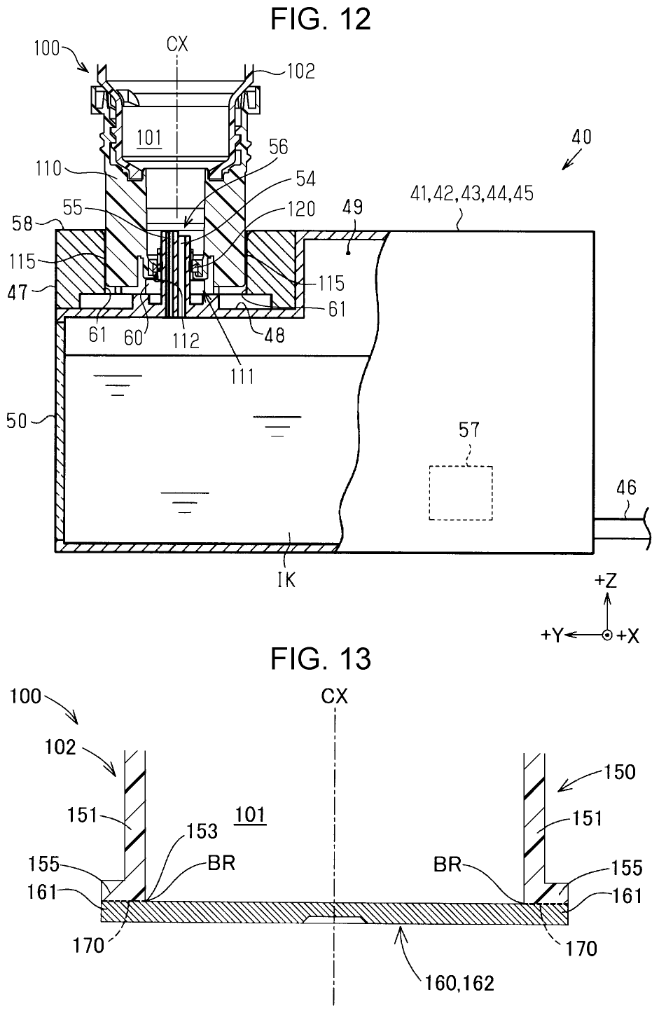

Referring to FIGS. 11 and 12, a process of refilling the ink into one of the ink tanks 41 to 45 from the liquid container 100 will be described. FIG. 11 is a partially cross-sectioned side view that schematically illustrates a state before the liquid container 100 is coupled to the adapter 47. FIG. 12 is a partially cross-sectioned side view that schematically illustrates a state after the liquid container 100 has been coupled to the adapter 47. The refilling of the ink into one of the ink tanks 41 to 45 is performed, for example, when the user confirms that the liquid level of the ink IK is at the lower limit mark 52 or lower through the viewing portion 50.

Referring to FIG. 11, the liquid container 100 is positioned so that the front end side is on the lower side and the rear end side is on the upper side and so that the central axis CX coincides with the Z-axis direction. Furthermore, the liquid container 100 is set so that the pair of fitting portions 115 of the liquid outlet member 110 are aligned in the front-rear direction of the ink tanks 41 to 45. Note that before the liquid container 100 is coupled to the adapter 47, since the valve member 120 is in a valve closed state in which the slit 121 of the valve member 120 is closed, even when the front end of the liquid container 100 is oriented in the gravitational direction, the ink is suppressed from flowing out from the outlet 112 by the valve member 120.

Subsequently, the outlet 112 of the liquid container 100 is positioned above the ink port 56 of one of the ink tanks 41 to 45 and the liquid container 100 is moved downwards. With the above, as illustrated in FIG. 12, the pipe portion 111 of the liquid outlet member 110 fits into the circular hole portion 60 of the adapter 47 and the fitting portions 115 of the liquid outlet member 110 is fitted into the rectangular hole portions 61 of the adapter 47. Note that in so doing, when the liquid container 100 is about to be coupled to one of the ink tanks 41 to 45 containing colored ink that does not match that of the liquid container 100, the discrimination protrusions 62 provided in the rectangular hole portions 61 cannot be fitted into the fitting groove portions 116 provided in the fitting portions 115. Accordingly, the liquid container 100 can be prevented from being erroneously coupled to one of the ink tanks 41 to 45 that contains the colored ink that does not match that of the liquid container 100.

Note that as described above, the ink supplying unit 40 includes pairs of rectangular hole portions 61 in which each pair includes the discrimination protrusions 62 provided in a point symmetrical manner with the center of the circular hole portion 60 as the point of symmetry. By configuring each pair of rectangular hole portions 61 in the above manner, the discrimination protrusions 62 can be fitted into the fitting groove portions 116 of the fitting portions 115 regardless of which of the pair of fitting portions 115 of the matching liquid outlet member 110 is oriented towards the front side. Accordingly, regardless of the orientation of the pair of fitting portions 115 in the front-rear direction, the liquid container 100 containing the matching ink can be coupled and, accordingly, user-friendliness is increased.

When the liquid outlet member 110 is fitted into the circular hole portion 60 and the rectangular hole portions 61 of the adapter 47, the ink port 56 at the middle of the circular hole portion 60 is inserted through the slit 121 of the valve member 120 and into the outlet 112 in the +Z direction. In so doing, since the height of the front end opening of the second flow path 55 is higher than the height of the front end opening of the first flow path 54 in the ink port 56, the second flow path 55 is inserted first into the outlet 112 and the ink in the liquid storing chamber 101 flows into the second flow path 55.

Subsequently, when the front end opening of the first flow path 54 is inserted into the outlet 112, the atmospheric air inside the ink storage chamber 49 of the relevant one of the ink tanks 41 to 45 flows into the liquid storing chamber 101 through the first flow path 54. As described above, the second flow path 55 of the ink port 56 functions as a liquid flow path, and the first flow path 54 functions as an atmospheric air flow path. Accordingly, even when the user does not perform any operation after the above, the ink inside the liquid container 100 and the atmospheric air inside the ink storage chamber 49 are exchanged and the ink is refilled into the ink storage chamber 49.

Note that when the ink port 56 is inserted into the outlet 112 with the liquid outlet member 110 in a tilted position, and the front end opening of the first flow path 54 is inserted inside the outlet 112 before the front end opening of the second flow path 55, the ink flows into the first flow path 54 and the atmospheric air flows into the second flow path 55. Accordingly, in the liquid container 100, the second flow path 55 may function as the atmospheric air flow path and the first flow path 54 may function as the liquid flow path.

### 1-3-5. First Member and Second Member that Constitute Container Body

Referring to FIG. 9, configurations of the first member 150 and the second member 160 that constitute the container body 102 will be described. The first member 150 includes a cylindrical side wall 151 that surrounds the liquid storing chamber 101 about the central axis CX. In the first exemplary embodiment, the side wall 151 is cylindrical. A central axis of the side wall 151 of the first member 150 coincides with the central axis CX of the liquid container 100. The first member 150 is fabricated by injection molding.

The first member 150 includes a first opening 152 surrounded by an end portion of the side wall 151 on the front end side, and a second opening 153 surrounded by an end portion of the side wall 151 on the rear end side. The liquid outlet member 110 is attached to the first opening 152. More specifically, an end portion of the pipe portion 111 on the rear end side that protrudes inside the connection portion 125 of the liquid outlet member 110 is fitted to the first opening 152.

In the first exemplary embodiment, the first member 150 includes, at a front end portion thereof, a front end diameter reduced portion 154 to which the liquid outlet member 110 is attached. The front end diameter reduced portion 154 is configured by a portion of the side wall 151 and is a portion in the first member 150 in which the diameter has been reduced with respect to a portion on the rear end side with respect to the front end diameter reduced portion 154. The first opening 152 is open at the front end portion of the front end diameter reduced portion 154. The male screw portion 103 described above is provided on the surface of the front end diameter reduced portion 154 on the external circumference side. When the liquid outlet member 110 is attached, the front end diameter reduced portion 154 is covered by the connection portion 125 of the liquid outlet member 110.

The second member 160 in the first exemplary embodiment is configured of a flat plate-shaped member. The second member 160 is configured of a disk-shaped member. The second member 160 is fabricated by injection molding. The second member 160 is joined to a rear end side of the first member 150 and seals the liquid storing chamber 101 from the second opening 153 side. In the first exemplary embodiment, the second member 160 is joined so as to close the second opening 153 of the first member 150, and forms a bottom wall 162 of the container body 102.

FIG. 13 is a schematic cross-sectional view in which a peripheral portion of a joint 170 between the first member 150 and the second member 160 illustrated in FIG. 9 has been extracted. In the first exemplary embodiment, the first member 150 includes a peripheral protrusion 155 at the periphery of the second opening 153. The peripheral protrusion 155 is provided at the periphery of the second opening 153 and extends outwards in the radial direction of the first member 150 from the side wall 151. An external circumferential edge portion 161 of the second member 160 is formed to oppose the peripheral protrusion 155 in the central axis direction.

In the first exemplary embodiment, the joint 170 between the first member 150 and the second member 160 is configured as a portion in which the peripheral protrusion 155 of the first member 150 and the external circumferential edge portion 161 of the second member 160 have been welded to each other. The peripheral protrusion 155 and the external circumferential edge portion 161 of the second member 160 are welded to each other across the entire circumference of the side wall 151 and along a boundary BR between the first member 150 and the second member 160 in the liquid storing chamber 101.

In the liquid container 100 of the first exemplary embodiment, the joint 170 is formed outside an area surrounded by the boundary BR between the first member 150 and the second member 160 when viewed in the central axis direction. When the joint 170 is provided in such a portion, access thereto with a tool or a device used in welding becomes easier and welding between the first member 150 and the second member 160 is facilitated. Accordingly, various joining techniques suitable for joining the first member 150 and the second member 160 can be used, and the sealing property of the liquid storing chamber 101 defined by the first member 150 and the second member 160 can be improved easily. Heat welding, for example, can be employed as the welding method. The welding method is not limited to any particular method and, for example, laser welding may be employed or ultrasonic welding may be employed.

Alternatively, solvent bonding that uses a solvent may be employed.

When the joint 170 is provided in the portion described above and when the joining between the first member 150 and the second member 160 is facilitated, the sealing property of the liquid storing chamber defined by the first member and the second member can be improved easily. Furthermore, by providing the joint 170 in the portion described above, welding can be performed while a load is applied to the peripheral protrusion 155 and the external circumferential edge portion 161, which are the welding objects, in the central axis direction, which is the direction in which the peripheral protrusion 155 and the external circumferential edge portion 161 oppose each other, and while the peripheral protrusion 155 and the external circumferential edge portion 161 adhere to each other. Accordingly, by joining the first member 150 and the second member 160 to each other, the second opening 153 of the first member 150 can be sealed in a more watertight manner. Accordingly, leakage of the liquid from the boundary between the first member 150 and the second member 160 can be suppressed.

Note that as described above, the first member 150 and the second member 160 can be joined to each other by various welding methods described above with the liquid container 100 of the first exemplary embodiment. While laser welding can be employed to join the first member 150 and the second member 160 to each other, in such a case, either one of the first member 150 and the second member 160 will be formed of a material through which a laser beam can be transmitted, and the other one will be formed of a material that can absorb the laser beam. On the other hand, when a welding method other than laser welding is employed, limitations in the materials of the first member 150 and the second member 160, which occurs when laser welding is employed, can be suppressed. In other words, there will be no limitations in the selection of the materials of the first member 150 and the second member 160, and the design freedom will be increased.

In the liquid container 100 of the first exemplary embodiment, the container body 102 including a liquid storing chamber 101 therein is formed by joining the first member 150 and the second member 160 that have been fabricated separately by injection molding. Compared with when an integral container body including therein the liquid storing chamber 101 is fabricated by blow molding, the above configuration can reduce the manufacturing time and increase productivity. Accordingly, a reduction in the manufacturing cost can be achieved.

### 2. Second Exemplary Embodiment

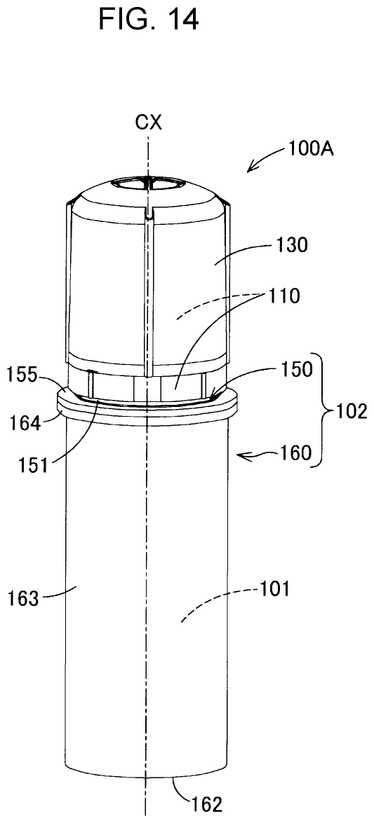

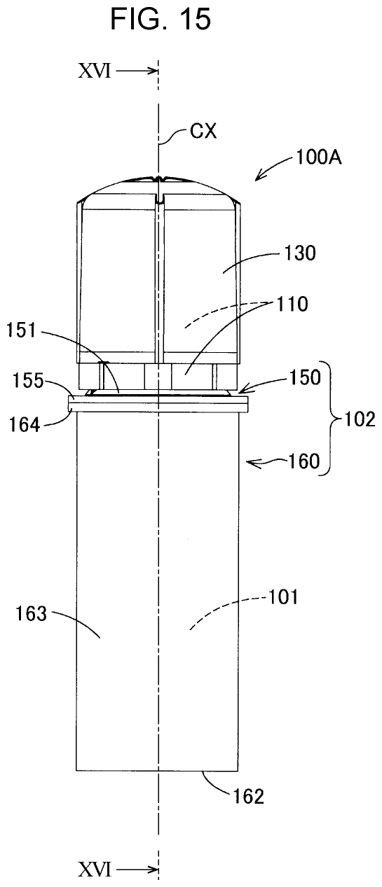

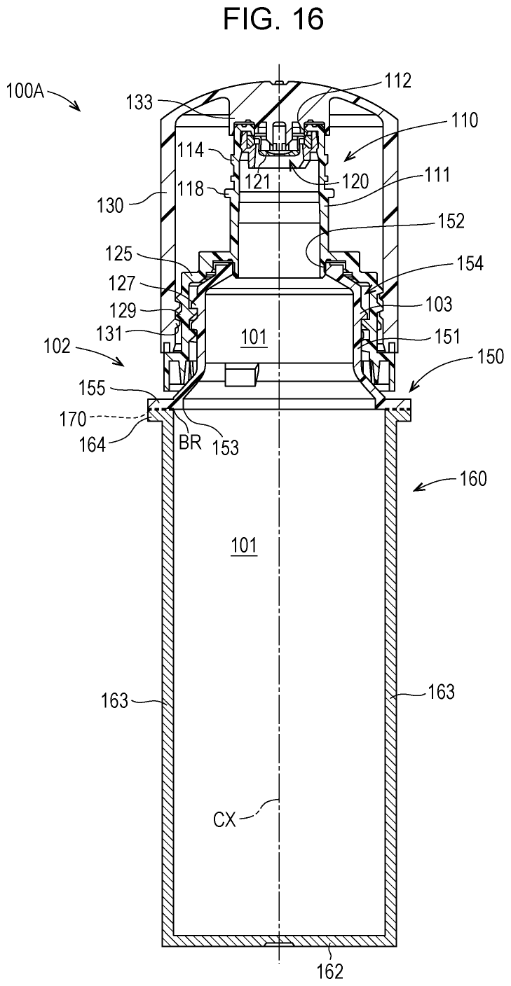

FIG. 14 is a schematic perspective view illustrating a configuration of a liquid container 100A according to a second exemplary embodiment. FIG. 15 is a schematic side view of the liquid container 100A and is a plan view of a lateral surface. FIG. 16 is a schematic cross-sectional view of the liquid container 100A cut along XVI-XVI and through the central axis CX illustrated in FIG. 15. A configuration of the liquid container 100A of the second exemplary embodiment is substantially the same as the configuration of the liquid container 100 of the first exemplary embodiment other than the points described below. Note that in the second exemplary embodiment, for the sake of convenience, the side wall 151 of the first member 150 will be referred to as a “first side wall 151”, and the peripheral protrusion 155 will be referred to as a “first peripheral protrusion 155”.

As illustrated in FIG. 16, in the second exemplary embodiment, the second opening 153 of the first member 150 is open in the end portion of the front end diameter reduced portion 154 on the rear end side. Furthermore, as illustrated in FIGS. 14 to 16, the first peripheral protrusion 155 is formed in the rear end of the front end diameter reduced portion 154.

As illustrated in FIG. 16, the second member 160 includes the bottom wall 162 that opposes the second opening 153 of the first member 150, and a cylindrical second side wall 163 that extends from the bottom wall 162 towards the first member 150 side and that surrounds a portion of the liquid storing chamber 101. As illustrated in FIG. 14, in the second exemplary embodiment, the second side wall 163 is cylindrical. A central axis of the second side wall 163 coincides with the central axis CX of the liquid container 100A. As illustrated in FIGS. 14 to 16, a second peripheral protrusion 164 that extends outwards in the radial direction is formed at the end portion of the second side wall 163 on the front end side and across the entire periphery of the second side wall 163. As illustrated in FIG. 16, a surface of the second peripheral protrusion 164 on the front end side is formed so as to oppose a surface of the first peripheral protrusion 155 on the rear end side in the central axis direction. In the liquid container 100A, the first member 150 and the second member 160 are joined to each other at the joint 170 in which the first peripheral protrusion 155 and the second peripheral protrusion 164 are welded to each other.

As illustrated in FIG. 16, in the liquid container 100A of the second exemplary embodiment, the joint 170 is formed outside an area surrounded by the boundary BR between the first member 150 and the second member 160 in the liquid storing chamber 101 when viewed in the central axis direction. Accordingly, similar to the liquid container 100 of the first exemplary embodiment described above, joining of the first member 150 and the second member 160 to each other is facilitated. According to the liquid container 100A of the second exemplary embodiment, the internal space constituting the liquid storing chamber 101 can be provided inside the second member 160 as well. Furthermore, the joint 170 can be provided at a portion other than an external circumferential edge of the bottom wall in the container body 102. Other than the above, the liquid container 100A of the second exemplary embodiment can obtain various advantageous effects similar to those described in the first exemplary embodiment.

### 3. Third Exemplary Embodiment

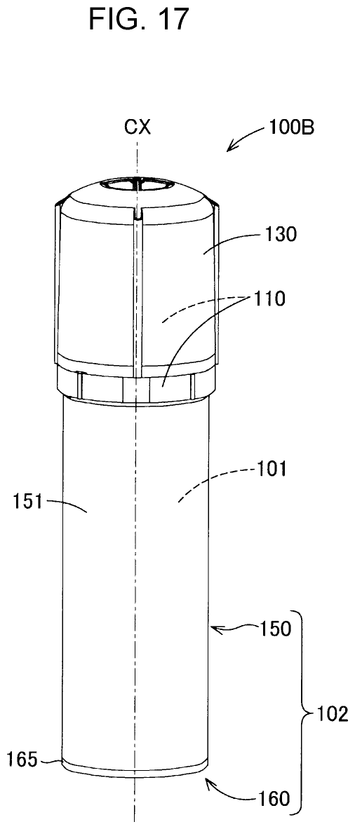

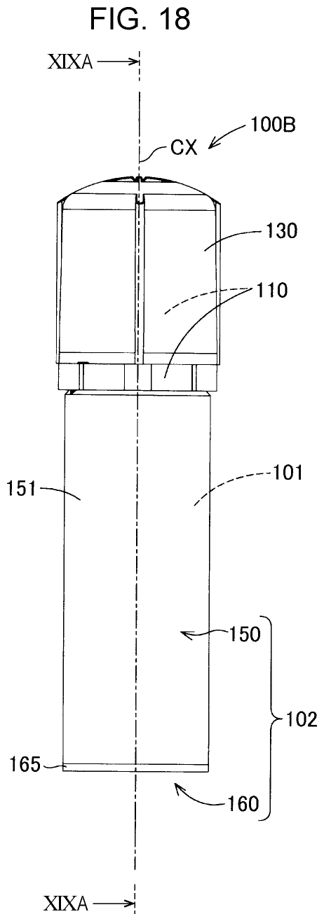

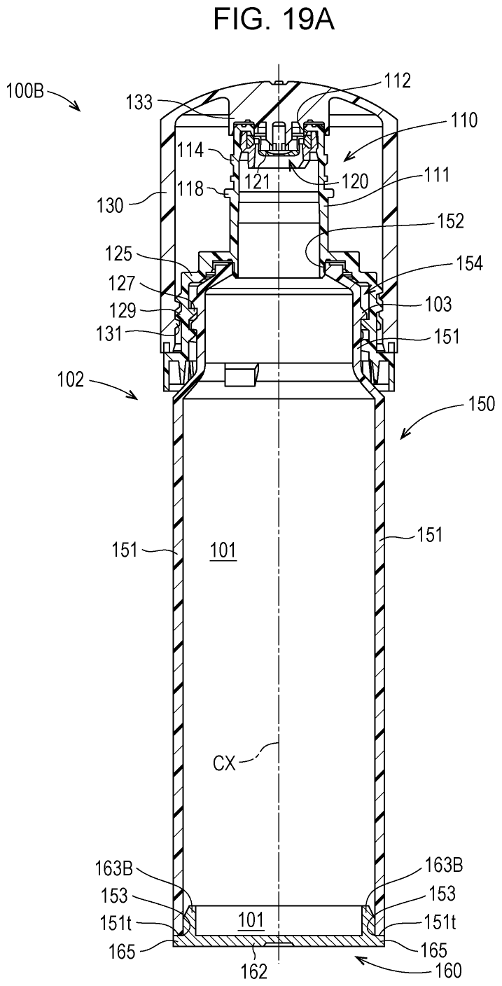

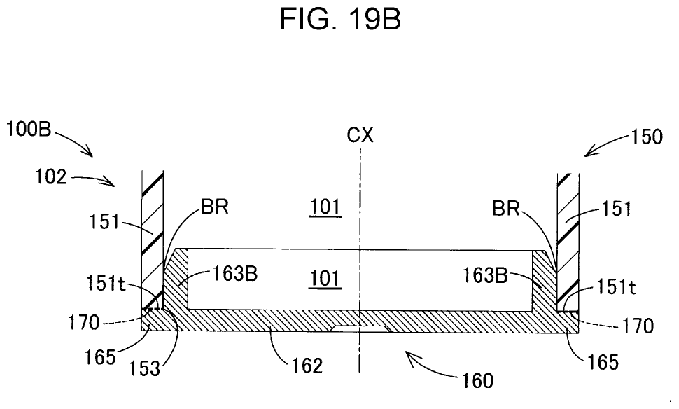

FIG. 17 is a schematic perspective view illustrating a configuration of a liquid container 100B according to a third exemplary embodiment. FIG. 18 is a schematic side view of the liquid container 100B and is a plan view of a lateral surface. FIG. 19A is a schematic cross-sectional view of the liquid container 100B cut along XIXA-XIXA and through the central axis CX illustrated in FIG. 18. FIG. 19B is a schematic cross-sectional view in which a peripheral portion of the joint 170 between the first member 150 and the second member 160 illustrated in FIG. 19A has been extracted. A configuration of the liquid container 100B of the third exemplary embodiment is substantially the same as the configuration of the liquid container 100 of the first exemplary embodiment other than the points described below. Note that in the third exemplary embodiment, for the sake of convenience, the side wall 151 of the first member 150 will be referred to as the “first side wall 151”.

In the third exemplary embodiment, the first member 150 does not include the peripheral protrusion 155 at an end portion of the first side wall 151 on the rear end side. Furthermore, in the third exemplary embodiment, the second member 160 includes the bottom wall 162 that opposes the second opening 153 of the first member 150, and a cylindrical second side wall 163B that extends from a surface of the bottom wall 162 on the front end side towards the first member 150 and that surrounds a portion of the liquid storing chamber 101. In the third exemplary embodiment, the second side wall 163B is cylindrical. A central axis of the second side wall 163B coincides with the central axis CX of the liquid container 100B.

In the third exemplary embodiment, the second side wall 163B is inserted inside the second opening 153 of the first member 150. An external circumferential surface of the second side wall 163B is in contact with the entire periphery of an internal circumferential surface of the first member 150 in a watertight manner. It is only sufficient that the second side wall 163B has a height tall enough to be in contact with the portion of the first member 150 on the rear end side alone.

As illustrated in FIGS. 19A and 19B, in the third exemplary embodiment, the bottom wall 162 of the second member 160 includes an extension portion 165 that extends outwards in the radial direction of the second side wall 163B. A surface of the extension portion 165 on the front end side is formed so as to, throughout the entire periphery thereof and in the central axis direction, oppose an end surface 151t of the first side wall 151 of the first member 150 on the rear end side. In the liquid container 100B, the joint 170 joining the first member 150 and the second member 160 to each other is configured as a portion in which the end surface 151t of the first side wall 151 on the rear end side and the extension portion 165 of the second member 160 are welded to each other.

As illustrated in FIG. 19B, in the liquid container 100B of the third exemplary embodiment, the joint 170 is formed outside an area surrounded by the boundary BR between the first member 150 and the second member 160 in the liquid storing chamber 101 when viewed in the central axis direction. Accordingly, similar to the liquid container 100 of the first exemplary embodiment described above, joining of the first member 150 and the second member 160 to each other is facilitated. Furthermore, the joint 170 is not formed in the portion protruding outwards in the radial direction from the first side wall 151; accordingly, when the user holds the liquid container 100B, the portion where the joint 170 is formed is prevented from being in the way.

In the liquid container 100B of the third exemplary embodiment, since the external circumferential surface of the second side wall 163B of the second member 160 and an internal circumferential surface of the first side wall 151 of the first member 150 are in surface contact with each other and are in contact with each other in a watertight manner, a seal line is formed. In the liquid container 100B, since the second opening 153 side of the liquid storing chamber 101 is double sealed with the seal line and the joint 170, leakage of the liquid from the liquid storing chamber 101 is suppressed further. Note that the portion where the external circumferential surface of the second side wall 163B and the internal circumferential surface of the first side wall 151 are in surface contact with each other may be welded by laser welding. By so doing, the bonding strength between the first member 150 and the second member 160 is further increased and the sealing property of the second opening 153 in the first member 150 is improved further. Other than the above, the liquid container 100B of the third exemplary embodiment can obtain various advantageous effects similar to those described in the first exemplary embodiment above.

### 4. Fourth Exemplary Embodiment

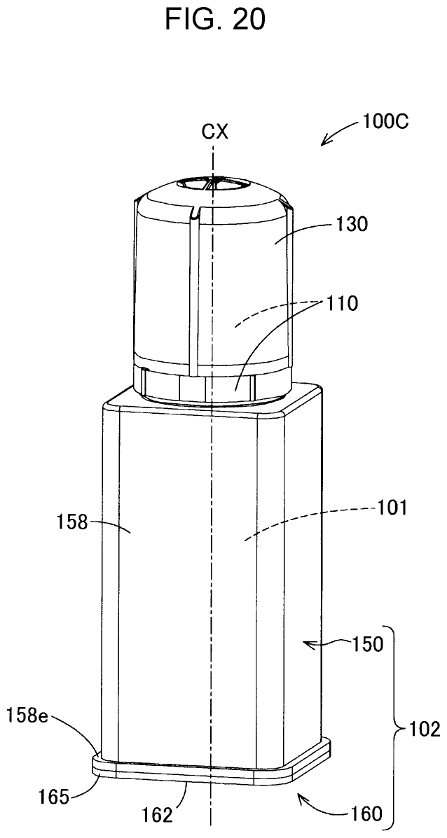

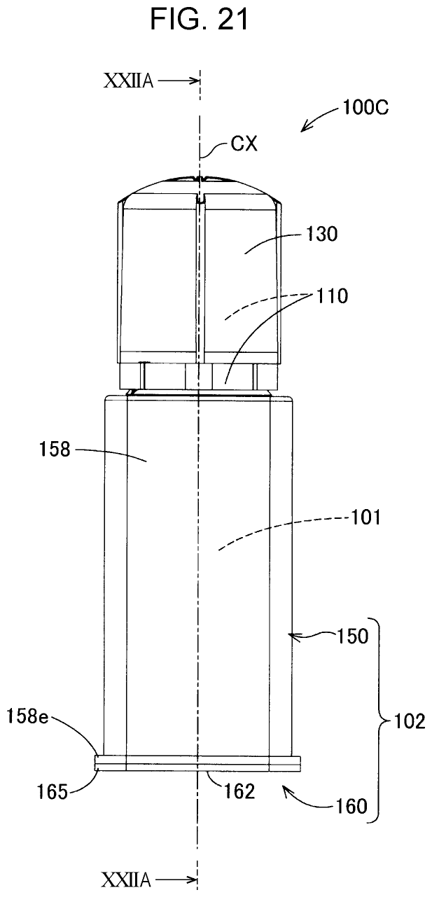

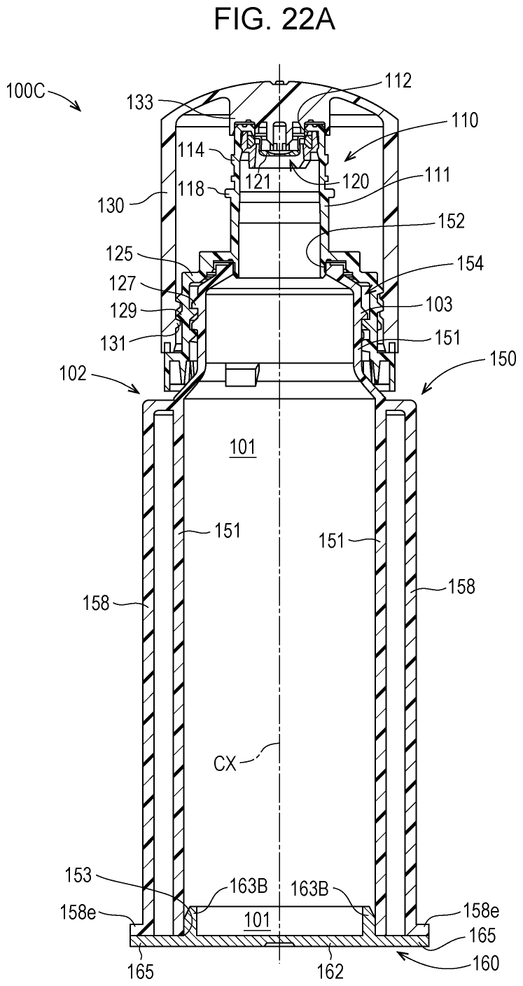

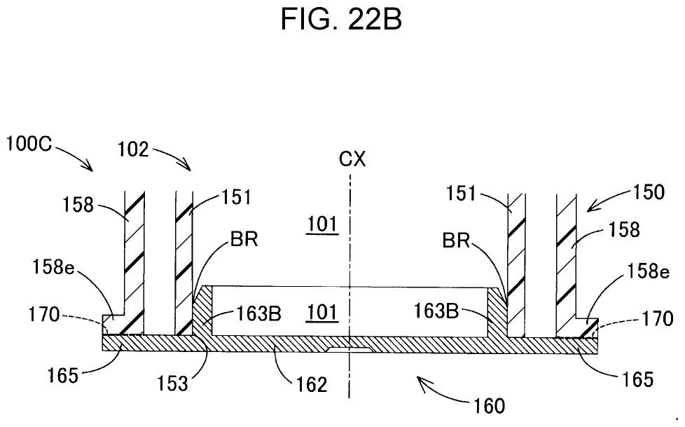

FIG. 20 is a schematic perspective view illustrating a configuration of a liquid container 100C according to a fourth exemplary embodiment. FIG. 21 is a schematic side view of the liquid container 100C and is a plan view of a lateral surface. FIG. 22A is a schematic cross-sectional view of the liquid container 100C cut along XXIIA-XXIIA and through the central axis CX illustrated in FIG. 21. FIG. 22B is a schematic cross-sectional view in which a peripheral portion of the joint 170 between the first member 150 and the second member 160 illustrated in FIG. 22A has been extracted. A configuration of the liquid container 100C of the fourth exemplary embodiment is substantially the same as the configuration of the liquid container 100B of the third exemplary embodiment other than the points described below.

As illustrated in FIG. 22A, in the fourth exemplary embodiment, the first member 150 includes a first-member-side external circumferential wall portion 158 outside the first side wall 151. As illustrated in FIGS. 20, 21, and 22A, the first-member-side external circumferential wall portion 158 has a cylindrical shape that surrounds an external circumference of the first side wall 151. The first-member-side external circumferential wall portion 158 is configured to have a rectangular cylindrical shape having a quadrilateral section. An end portion of the first-member-side external circumferential wall portion 158 on the front end side is bent towards the central axis CX and is coupled to a rear end of the front end diameter reduced portion 154. The first-member-side external circumferential wall portion 158 extends in the central axis direction to a position that comes in contact with the extension portion 165 of the second member 160. A protrusion 158e that protrudes outwards in the radial direction of the first-member-side external circumferential wall portion 158 is provided in an end portion of the first-member-side external circumferential wall portion 158 on the rear end side. In the fourth exemplary embodiment, the protrusion 158e is formed across the entire periphery of the first-member-side external circumferential wall portion 158 and the external circumference has a quadrilateral shape. In another exemplary embodiment, the protrusion 158e may be provided only in a portion of an external circumference of the first-member-side external circumferential wall portion 158.

As illustrated in FIG. 20, in the fourth exemplary embodiment, an external circumference of the bottom wall 162 included in the second member 160 has a quadrilateral shape. As illustrated in FIGS. 20, 21, 22A, and 22B, in the fourth exemplary embodiment, the extension portion 165 of the bottom wall 162 is formed so as to, in the central axis direction, oppose a surface of the protrusion 158e on the rear end side provided in the first-member-side external circumferential wall portion 158. Referring to FIGS. 22A and 22B, similar to that described in the third exemplary embodiment, the second side wall 163B is inserted in the second opening 153, and the external circumferential surface is in contact with the entire periphery of the internal circumferential surface of the first side wall 151 in a watertight manner.

Referring to FIG. 22B, in the fourth exemplary embodiment, the joint 170 joining the first member 150 and the second member 160 to each other is configured as a portion in which the protrusion 158e provided in the end portion of the first-member-side external circumferential wall portion 158 on the rear end side and the bottom wall 162 of the second member 160 have been welded to each other. When viewed in the central axis direction, the joint 170 is positioned outside the boundary BR between the first member 150 and the second member 160 in the liquid storing chamber 101. Accordingly, similar to the exemplary embodiments described above, joining of the first member 150 and the second member 160 to each other is facilitated in the liquid container 100C of the fourth exemplary embodiment as well.

In the liquid container 100C of the fourth exemplary embodiment, the second opening 153 side of the liquid storing chamber 101 is double sealed with the seal line formed by the internal circumferential surface of the first side wall 151 and the external circumferential surface of the second side wall 163B that are in surface contact with each other, and with the joint 170. Furthermore, in the fourth exemplary embodiment, the seal line formed between the internal circumferential surface of the first side wall 151 and the external circumferential surface of the second side wall 163B, and the joint 170 are formed so as to be separated from each other in the radial direction. With such a structure, leakage of the liquid from the liquid storing chamber 101 is further suppressed compared with the configuration of the third exemplary embodiment.

In the liquid container 100C of the fourth exemplary embodiment, since the first side wall 151 is covered by the first-member-side external circumferential wall portion 158, the first side wall 151 is prevented from being damaged. Accordingly, leakage of the liquid from the liquid storing chamber 101 due to damage in the first side wall 151 is prevented. Other than the above, the liquid container 100C of the fourth exemplary embodiment can obtain various advantageous effects similar to those described in the exemplary embodiments above.

### 5. Fifth Exemplary Embodiment

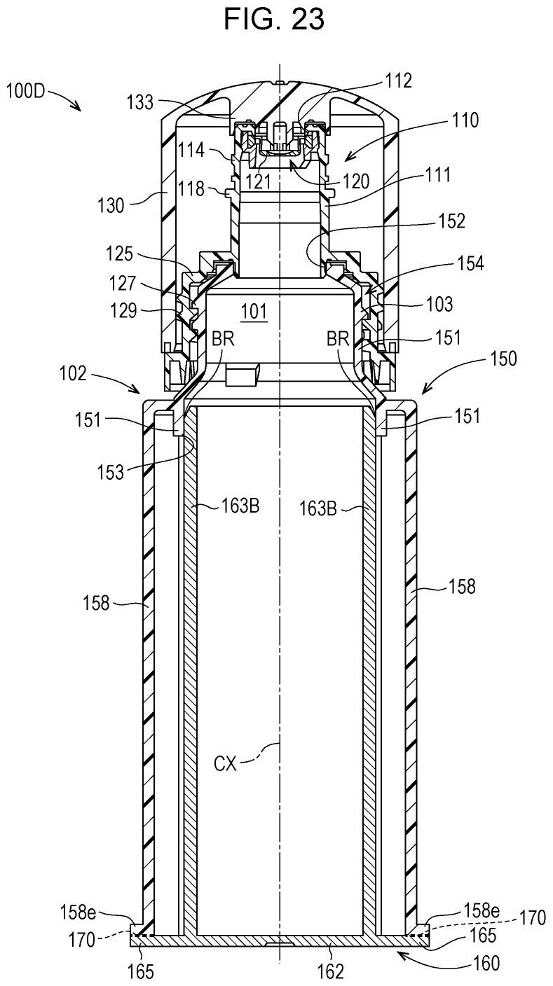

FIG. 23 is a schematic cross-sectional view of a liquid container 100D of a fifth exemplary embodiment cut along a plane including the central axis CX. A configuration of the liquid container 100D of the fifth exemplary embodiment is substantially the same as the configuration of the liquid container 100C of the fourth exemplary embodiment other than that a dimension of the first side wall 151 in the central axis direction is shorter and that the dimension of the second side wall 163B in the central axis direction is, in accordance with the above, longer. In the liquid container 100D, the end portion of the first side wall 151 on the rear end side and an end portion of the second side wall 163B on the front end side are positioned closer to the end portion of the front end diameter reduced portion 154 on the rear end side with respect to an end portion of the container body 102 on the rear end side. A distance between the second opening 153 and the joint 170 in the liquid container 100D is longer than that in the liquid container 100C of the fourth exemplary embodiment. Accordingly, even when the liquid in the liquid storing chamber 101 leaks through the boundary BR between the first member 150 and the second member 160 in the second opening 153, the liquid that has leaked is, compared with the fourth exemplary embodiment, further prevented from leaking to a portion external to the container body 102 through the joint 170. Other than the above, the liquid container 100D of the fifth exemplary embodiment can obtain various advantageous effects similar to those described in the exemplary embodiments above.

### 6. Sixth Exemplary Embodiment

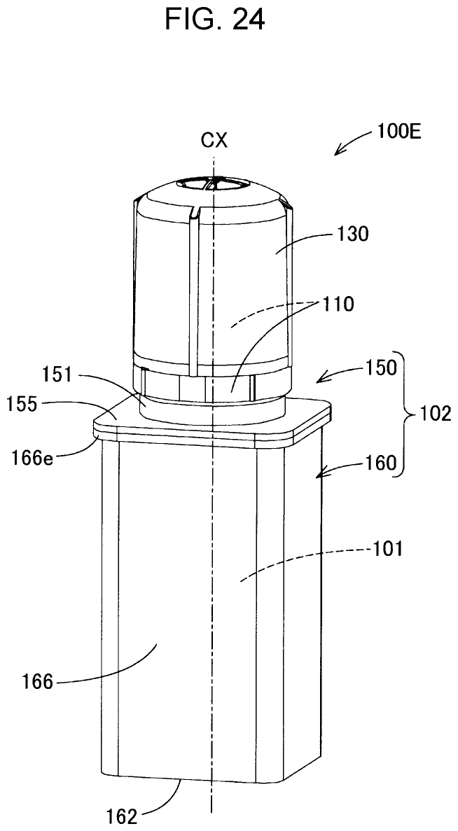

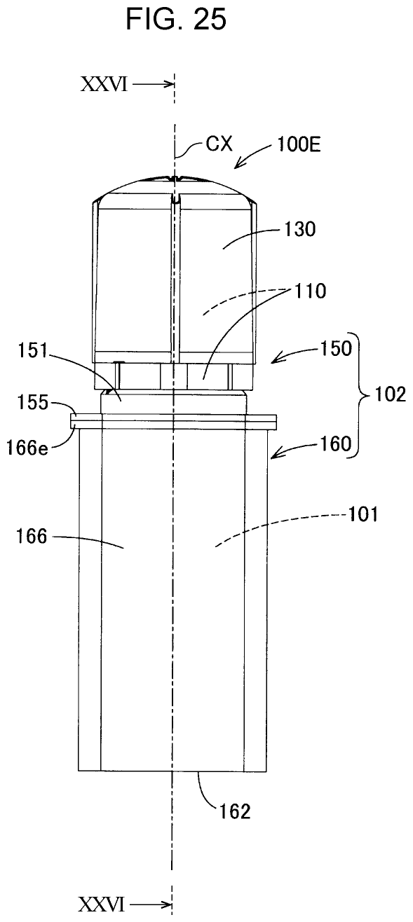

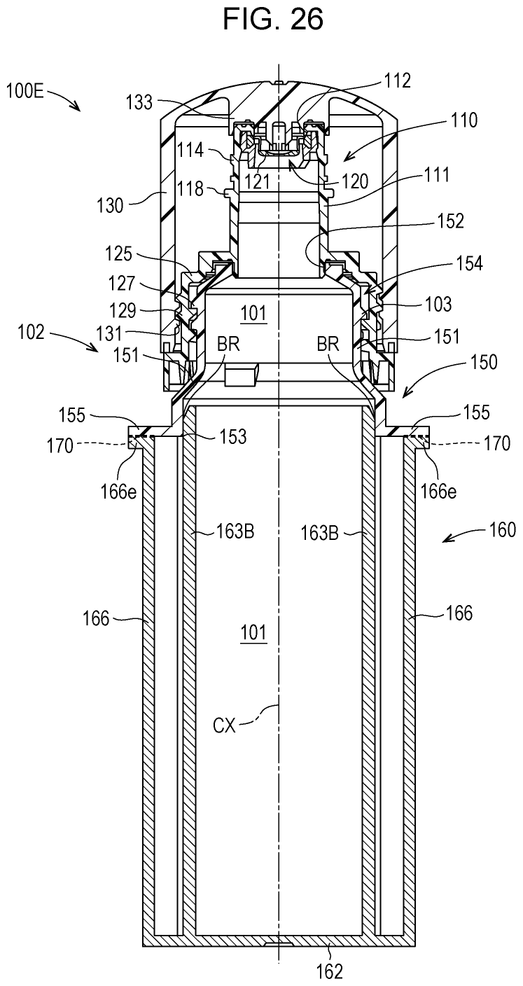

FIG. 24 is a schematic perspective view illustrating a configuration of a liquid container 100E according to a sixth exemplary embodiment. FIG. 25 is a schematic side view of the liquid container 100E and is a plan view of a lateral surface. FIG. 26 is a schematic cross-sectional view of the liquid container 100E cut along XXVI-XXVI and through the central axis CX illustrated in FIG. 25. A configuration of the liquid container 100E of the sixth exemplary embodiment is substantially the same as the configuration of the liquid container 100D of the fifth exemplary embodiment other than the points described below.

As illustrated in FIG. 26, the first-member-side external circumferential wall portion 158 is not provided in the first member 150 of the sixth exemplary embodiment. The peripheral protrusion 155 similar to those described in the first exemplary embodiment and the second exemplary embodiment is provided at the periphery of the second opening 153 in the first member 150 of the sixth exemplary embodiment. As illustrated in FIG. 24, the peripheral protrusion 155 has a quadrilateral external circumference that corresponds to the shapes of a second-member-side external circumferential wall portion 166 of the second member 160 and a protruding edge portion 166e that are described later.

As illustrated in FIG. 26, the second member 160 includes the second-member-side external circumferential wall portion 166 on the outside of the second side wall 163B. The second-member-side external circumferential wall portion 166 extends towards the first member 150 side in the central axis direction from an end of the external circumference of the bottom wall 162 to where the second opening 153 of the first member 150 is positioned. As illustrated in FIGS. 24, 25, and 26, the second-member-side external circumferential wall portion 166 has a cylindrical shape that surrounds the external circumference of the second side wall 163B. As illustrated in FIG. 24, the second-member-side external circumferential wall portion 166 in the sixth exemplary embodiment has a quadrilateral cross section and is configured to have a rectangular cylindrical shape.

As illustrated in FIGS. 24, 25, and 26, the protruding edge portion 166e that protrudes outwards in the radial direction of the second-member-side external circumferential wall portion 166 is provided at an end portion of the second-member-side external circumferential wall portion 166 on the first member 150 side. In the sixth exemplary embodiment, the protruding edge portion 166e is formed across the entire periphery of the second-member-side external circumferential wall portion 166 and has a quadrilateral external circumference. A surface of the protruding edge portion 166e on the front end side opposes a surface of the peripheral protrusion 155, which is included in the first member 150, on the rear end side in the central axis direction. Note that in the other exemplary embodiments, the protruding edge portion 166e may be provided in only a portion of the external circumference of the second-member-side external circumferential wall portion 166.

Referring to FIG. 26, in the liquid container 100E of the sixth exemplary embodiment, the joint 170 joining the first member 150 and the second member 160 to each other is configured as a portion in which the peripheral protrusion 155 of the first member 150 and the protruding edge portion 166e provided in the second-member-side external circumferential wall portion 166 of the second member 160 are welded to each other. When viewed in the central axis direction, the joint 170 is positioned outside an area surrounded by the boundary BR between the first member 150 and the second member 160 in the liquid storing chamber 101. Accordingly, similar to the exemplary embodiments described above, joining of the first member 150 and the second member 160 to each other is facilitated in the liquid container 100E of the sixth exemplary embodiment as well.

In the sixth exemplary embodiment as well, the second side wall 163B of the second member 160 is, similar to the liquid container 100D of the fifth exemplary embodiment, inserted in the second opening 153 of the first member 150, and the external circumferential surface is in contact with the entire periphery of the internal circumferential surface of the first side wall 151 in a watertight manner. Accordingly, in the liquid container 100E as well, the second opening 153 of the first member 150 is double sealed with the seal line formed by surface contact between the internal circumferential surface of the first side wall 151 and the external circumferential surface of the second side wall 163B, and the joint 170 formed by welding.

In the liquid container 100E of the sixth exemplary embodiment, since the second side wall 163B is covered by the second-member-side external circumferential wall portion 166, the second side wall 163B is prevented from being damaged. Accordingly, leakage of the liquid from the liquid storing chamber 101 due to damage in the second side wall 163B is prevented. Other than the above, the liquid container 100E of the sixth exemplary embodiment can obtain various advantageous effects similar to those described in the exemplary embodiments above.

### 7. Seventh Exemplary Embodiment

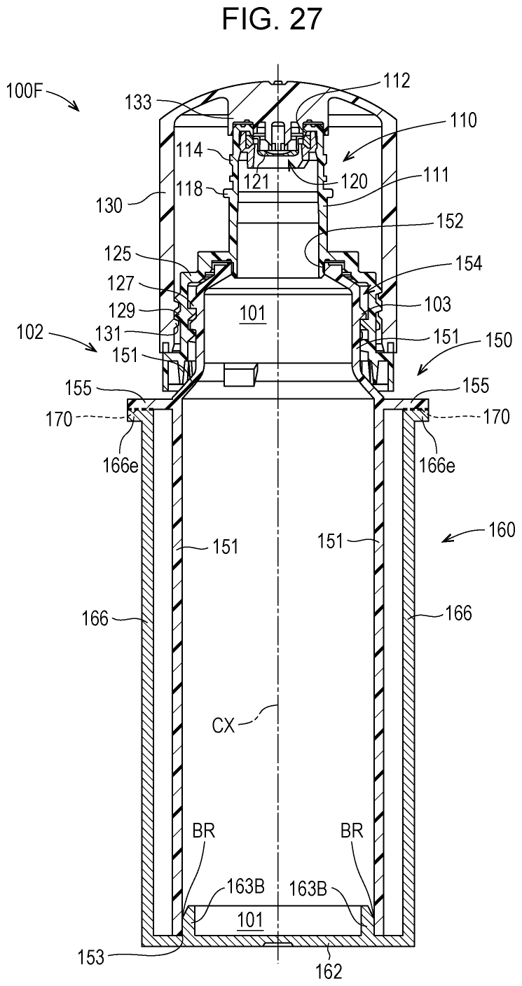

FIG. 27 is a schematic cross-sectional view of a liquid container 100F of a seventh exemplary embodiment cut along a plane including the central axis CX. A configuration of the liquid container 100F of the seventh exemplary embodiment is substantially the same as the configuration of the liquid container 100E of the sixth exemplary embodiment other than the points described below. In the liquid container 100F of the seventh exemplary embodiment, the first side wall 151 is extended in the central axis direction to the bottom wall 162 of the second member 160 without changing the position of the peripheral protrusion 155. Furthermore, the length of the second side wall 163B in the central axis direction is shortened in accordance with the position of the end portion of the extended first side wall 151 on the rear end side. In the liquid container 100F of the seventh exemplary embodiment, since the first side wall 151 is covered by the second-member-side external circumferential wall portion 166, the first side wall 151 is prevented from being damaged. Furthermore, a distance between the second opening 153 and the joint 170 is longer than that in the liquid container 100E of the sixth exemplary embodiment. Accordingly, even when the liquid in the liquid storing chamber 101 leaks through the boundary BR between the first member 150 and the second member 160 in the second opening 153, the liquid that has leaked is, compared with the sixth exemplary embodiment, further prevented from leaking to a portion external to the container body 102 through the joint 170. Other than the above, the liquid container 100F of the seventh exemplary embodiment can obtain various advantageous effects similar to those described in the exemplary embodiments above.

### 8. Eighth Exemplary Embodiment

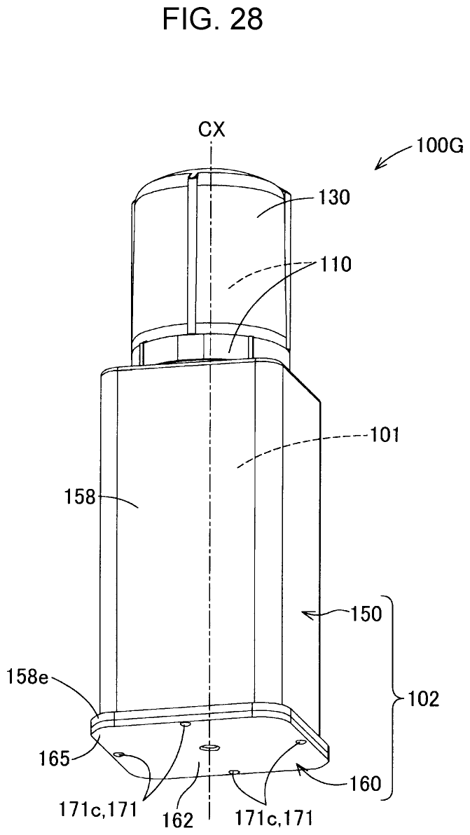

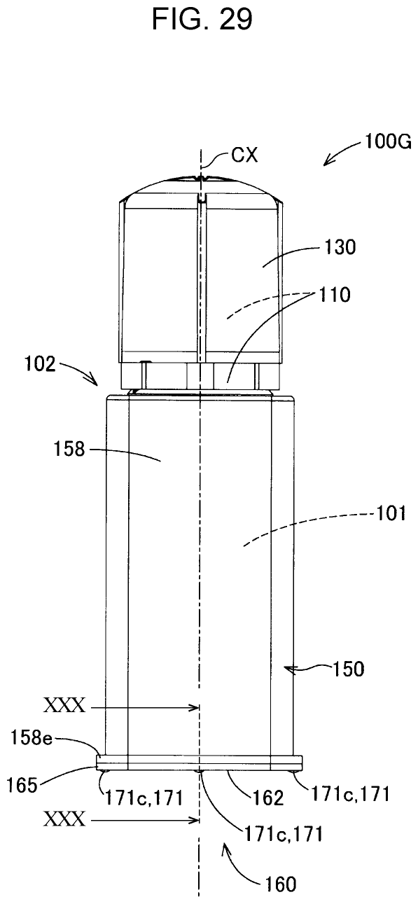

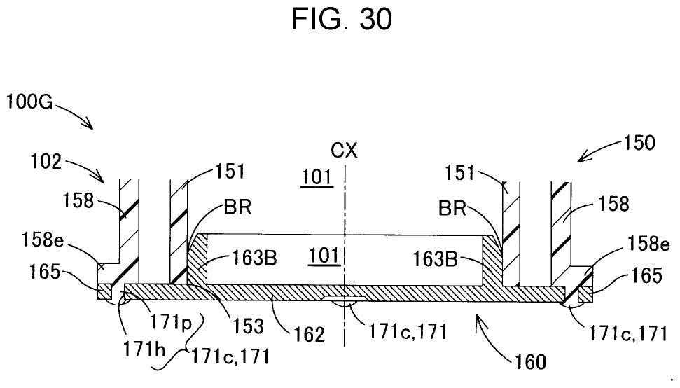

FIG. 28 is a schematic perspective view illustrating a configuration of a liquid container 100G according to an eighth exemplary embodiment. FIG. 29 is a schematic side view of the liquid container 100G and is a plan view of a lateral surface. FIG. 30 is a schematic cross-sectional view of the liquid container 100G cut along XXX-XXX and through the central axis CX illustrated in FIG. 29. A configuration of the liquid container 100G of the eighth exemplary embodiment is substantially the same as the configuration of the liquid container 100C of the fourth exemplary embodiment illustrated in FIGS. 20 to 22B other than that the first member 150 and the second member 160 are, in place of the joint 170, joined to each other by a joint 171 formed by heat caulking.

As illustrated in FIG. 30, the joint 171 includes heat caulking portions 171c that join the protrusion 158e of the first-member-side external circumferential wall portion 158 and the extension portion 165 to each other by heat caulking. As illustrated in FIG. 28, a plurality of heat caulking portions 171c are arranged in the joint 171 along the external circumference of the first-member-side external circumferential wall portion 158. Four heat caulking portions 171c are provided in the eighth exemplary embodiment. A single heat caulking portion 171c is provided at the middle of each side of the external circumference of the first-member-side external circumferential wall portion 158.

As illustrated in FIG. 30, the heat caulking portions 171c include columnar portions 171p that protrude from the protrusion 158e in the central axis direction, and through holes 171h, which penetrate through the extension portion 165 and though which the columnar portions 171p are inserted. End portions of the columnar portions 171p on the rear end side are widened in the radial direction at positions where the columnar portions 171p protrude to the rear end side of the extension portion 165 from the through holes 171h and are engaged to peripheral portions of the through holes 171h.

In the liquid container 100G of the eighth exemplary embodiment, the joint 171 formed by heat caulking can join the first member 150 and the second member 160 to each other more easily compared to when the protrusion 158e and the extension portion 165 are welded to each other in the entire circumference of the first-member-side external circumferential wall portion 158. Furthermore, in the liquid container 100G of the eighth exemplary embodiment, as illustrated in FIG. 30 and similar to the liquid container 100C of the fourth exemplary embodiment, the second opening 153 is sealed by surface contact between the internal circumferential surface of the first side wall 151 and the external circumferential surface of the second side wall 163B. Accordingly, leakage of the liquid in the liquid storing chamber 101 through the boundary BR between the first member 150 and the second member 160 can be suppressed. Other than the above, the liquid container 100G of the eighth exemplary embodiment can obtain various advantageous effects similar to those described in the exemplary embodiments above.

### 9. Ninth Exemplary Embodiment

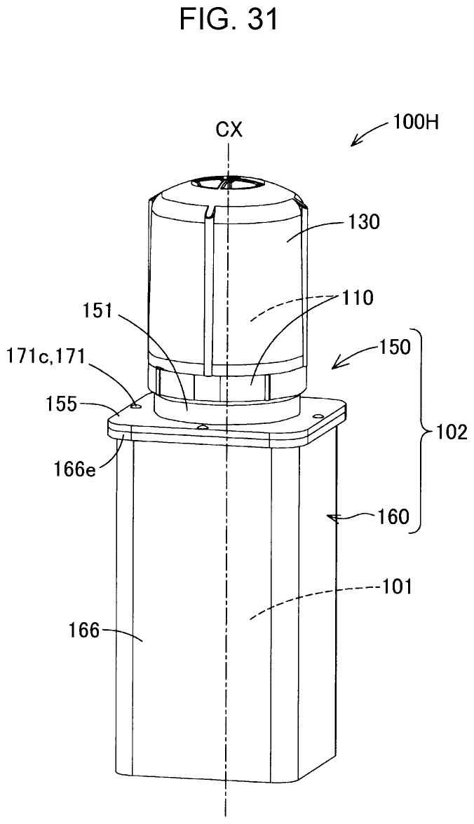

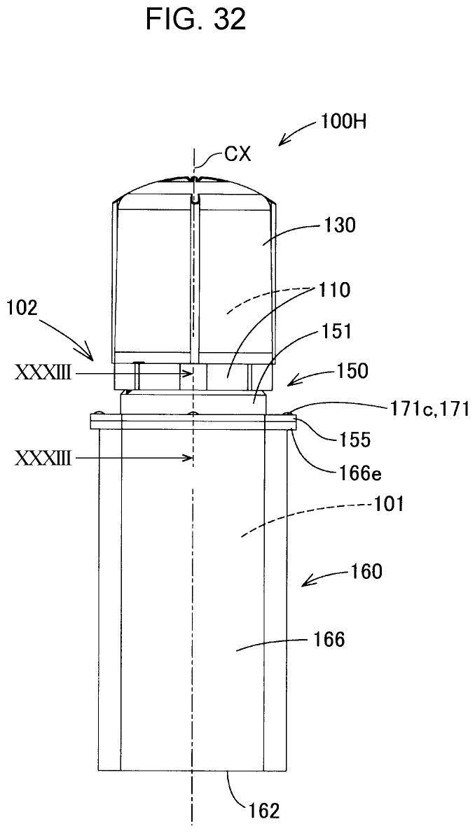

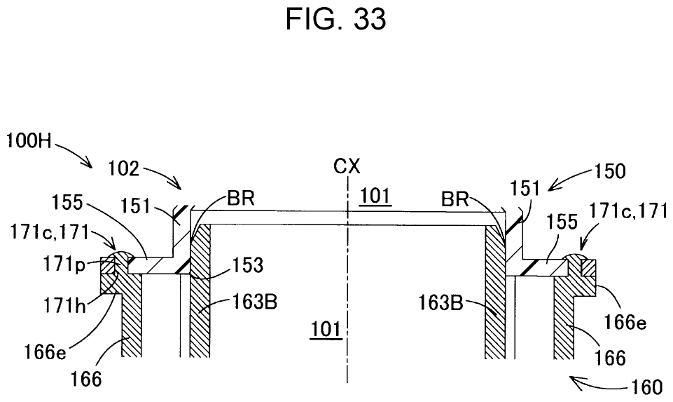

FIG. 31 is a schematic perspective view illustrating a configuration of a liquid container 100H according to a ninth exemplary embodiment. FIG. 32 is a schematic side view of the liquid container 100H and is a plan view of a lateral surface. FIG. 33 is a schematic cross-sectional view of the liquid container 100H cut along XXXIII-XXXIII and through the central axis CX illustrated in FIG. 32. The liquid container 100H of the ninth exemplary embodiment corresponds to the liquid container 100E of the sixth exemplary embodiment in which the joint 171 formed by heat caulking described in the eighth exemplary embodiment illustrated in FIGS. 24 to 26 is adopted in place of the joint 170 formed by welding. In the liquid container 100H of the ninth exemplary embodiment, the peripheral protrusion 155 of the first member 150 and the protruding edge portion 166e of the second member 160 are joined to each other by the heat caulking portions 171c provided in plurality of portions. In the liquid container 100H of the ninth exemplary embodiment, similar to the liquid container 100G of the eighth exemplary embodiment, the first member 150 and the second member 160 can be easily joined to each other by heat caulking. Furthermore, as illustrated in FIG. 33, since the second opening 153 is sealed in a watertight manner by surface contact between the internal circumferential surface of the first side wall 151 and the external circumferential surface of the second side wall 163B, leakage of the liquid from the liquid storing chamber 101 can be suppressed. Other than the above, the liquid container 100H of the ninth exemplary embodiment can obtain various advantageous effects similar to those described in the exemplary embodiments above.

### 10. Tenth Exemplary Embodiment

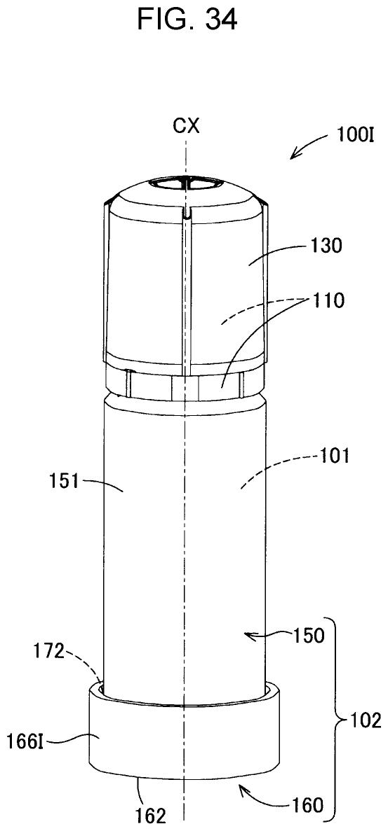

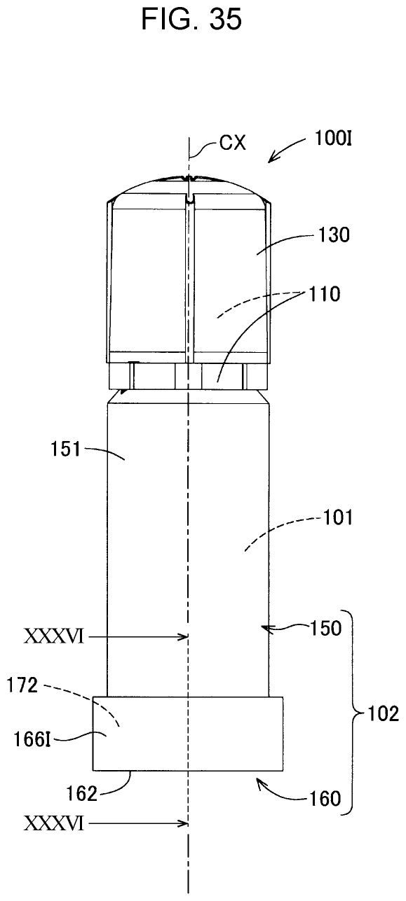

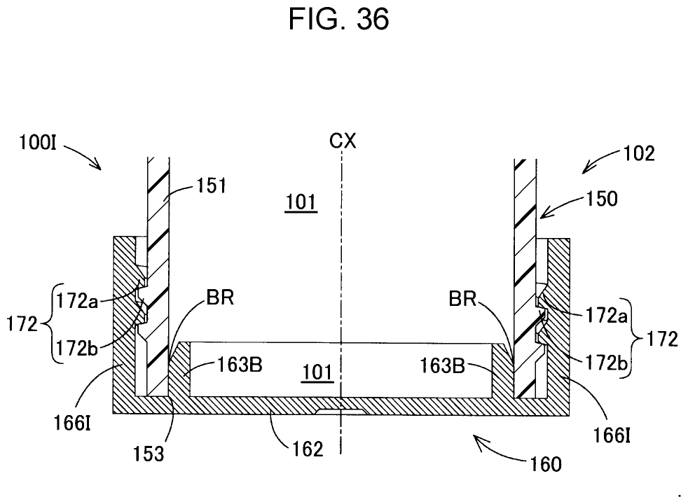

FIG. 34 is a schematic perspective view illustrating a configuration of a liquid container 100I according to a tenth exemplary embodiment. FIG. 35 is a schematic side view of the liquid container 100I and is a plan view of a lateral surface. FIG. 36 is a schematic cross-sectional view of the liquid container 100I cut along XXXVI-XXXVI and through the central axis CX illustrated in FIG. 35. A configuration of the liquid container 100I of the tenth exemplary embodiment is substantially the same as the configuration of the liquid container 100B of the third exemplary embodiment illustrated in FIGS. 17 to 19B other than the points described below.

In the liquid container 100I of the tenth exemplary embodiment, in place of the joint 170 formed by welding, the joint between the first member 150 and the second member 160 is configured of a screw portion 172 described below. As illustrated in FIG. 36, in the second member 160 of the liquid container 100I, a second-member-side external circumferential wall portion 1661 that extends in the central axis direction towards the first member 150 side is provided in the external circumferential edge of the bottom wall 162. As illustrated in FIGS. 34 to 36, the second-member-side external circumferential wall portion 1661 is cylindrical and surrounds the external circumference of the first side wall 151. In the tenth exemplary embodiment, the second-member-side external circumferential wall portion 1661 is cylindrical and surrounds the end portion of the first side wall 151 on the rear end side. As illustrated in FIG. 36, the screw portion 172 is provided in a portion where an internal circumferential surface of the second-member-side external circumferential wall portion 1661 and an external circumferential surface of the first side wall 151 oppose each other. A female screw portion 172a is provided in the internal circumferential surface of the second-member-side external circumferential wall portion 1661, and a male screw portion 172b screwed together with the female screw portion 172a is provided in the external circumferential surface of the first side wall 151.

In the liquid container 100I of the tenth exemplary embodiment, the first member 150 and the second member 160 can be joined to each other easily with the screw portion 172. Furthermore, in the liquid container 100I of the tenth exemplary embodiment, as illustrated in FIG. 36 and similar to the liquid container 100B of the third exemplary embodiment, a seal line is formed by surface contact between the external circumferential surface of the second side wall 163B and the internal circumferential surface of the first side wall 151. With the above, since the second opening 153 of the first member 150 is double sealed with the seal line and the screw portion 172 outside the seal line, leakage of the liquid from the liquid storing chamber 101 can be suppressed in a more effective manner. Furthermore, the liquid container 100I of the tenth exemplary embodiment can protect the seal line formed between the external circumferential surface of the second side wall 163B and the internal circumferential surface of the first side wall 151 with the second-member-side external circumferential wall portion 1661. Other than the above, the liquid container 100I of the tenth exemplary embodiment can obtain various advantageous effects similar to those described in the exemplary embodiments above.

### 11. Eleventh Exemplary Embodiment

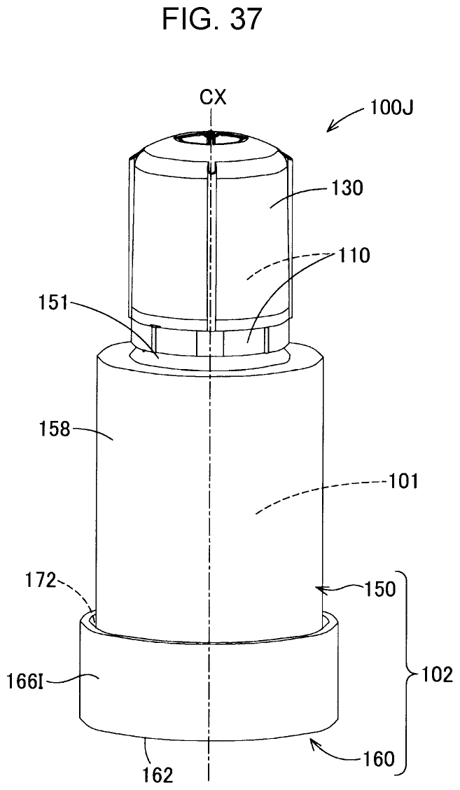

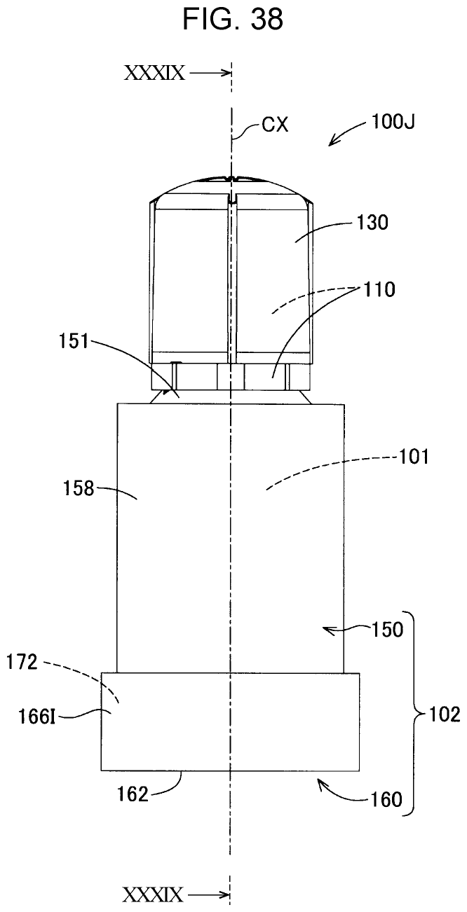

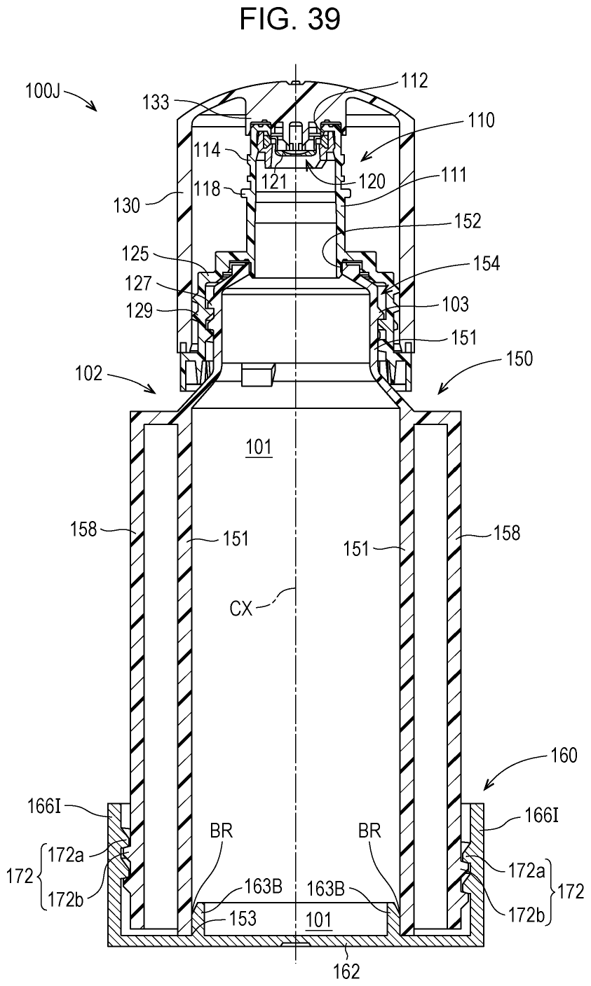

FIG. 37 is a schematic perspective view illustrating a configuration of a liquid container 100J according to an eleventh exemplary embodiment. FIG. 38 is a schematic side view of the liquid container 100J and is a plan view of a lateral surface. FIG. 39 is a schematic cross-sectional view of the liquid container 100J cut along XXXIX-XXXIX and through the central axis CX illustrated in FIG. 38. A configuration of the liquid container 100J of the eleventh exemplary embodiment is substantially the same as the configuration of the liquid container 100C of the fourth exemplary embodiment illustrated in FIGS. 20 to 22B other than the points described below.

The liquid container 100J of the eleventh exemplary embodiment corresponds to the liquid container 100C of the fourth exemplary embodiment in which, in place of the joint 170 formed by welding, the screw portion 172 described in the tenth exemplary embodiment is applied as the joint between the first member 150 and the second member 160. As illustrated in FIGS. 37 to 39, in the eleventh exemplary embodiment, the first-member-side external circumferential wall portion 158 is cylindrical and the bottom wall 162 has a circular external circumference. As illustrated in FIG. 39, the protrusion 158e described in the fourth exemplary embodiment is not provided in the end portion of the first-member-side external circumferential wall portion 158 on the rear end side. As illustrated in FIGS. 37 to 39, the second-member-side external circumferential wall portion 1661 similar to that described in the tenth exemplary embodiment is provided at the external circumferential edge of the bottom wall 162 of the second member 160. The second-member-side external circumferential wall portion 1661 surrounds the end portion of the first-member-side external circumferential wall portion 158 on the rear end side. The screw portion 172 is provided at a portion where the internal circumferential surface of the second-member-side external circumferential wall portion 1661 and an external circumferential surface of the first-member-side external circumferential wall portion 158 oppose each other. The female screw portion 172a is provided in the internal circumferential surface of the second-member-side external circumferential wall portion 1661 and the male screw portion 172b screwed together with the female screw portion 172a is provided in the external circumferential surface of the first-member-side external circumferential wall portion 158.

In the liquid container 100J of the eleventh exemplary embodiment, the first member 150 and the second member 160 can be joined to each other easily with the screw portion 172. Other than the above, the liquid container 100J of the eleventh exemplary embodiment can obtain various advantageous effects similar to those described in the exemplary embodiments above.

### 12. Other Exemplary Embodiments

The various configurations described in the exemplary embodiments described above can be changed in the following manner, for example. Other exemplary embodiments described below are, in a similar manner to the exemplary embodiments described above, regarded as examples of configurations that embody the technique of the present disclosure.

Another Exemplary Embodiment 1

The shapes of the liquid containers 100, and 100A to 100J may be changed from those described in the exemplary embodiments described above. For example, the external shape of the container body 102 is not limited to a columnar shape or a square columnar shape. The container body 102 may have a shape in which the sectional area increases from the front end side towards the rear end side. Furthermore, it is only sufficient that the first side wall 151, the second side walls 163 and 163B, the first-member-side external circumferential wall portion 158, and the second-member-side external circumferential wall portion 166 have a cylindrical shape and may have an elliptical cross-sectional shape or a polygonal cross-sectional shape.

Another Exemplary Embodiment 2

The configuration of the liquid outlet member 110 is not limited to that described in each of the exemplary embodiments described above. For example, the liquid outlet member 110 does not have to include the valve member 120. Furthermore, the liquid outlet member 110 may be configured of a tube-shaped member that can be attached to the first opening 152.

Another Exemplary Embodiment 3

The configurations of the exemplary embodiments described above can be combined as appropriate. For example, in place of the joint 170, the joint 171 formed by heat caulking can be applied to the liquid container 100 of the first exemplary embodiment. However, in such a case, it is desirable that a seal portion is provided in the boundary between the first member 150 and the second member 160. Furthermore, in place of the joint 170, the joint 171 formed by heat caulking can be applied to the liquid container 100D of the fifth exemplary embodiment or to the liquid container 100F of the seventh exemplary embodiment.

### 13. Example Configurations

The technique of the present disclosure is not limited to the exemplary embodiments and the examples described above and may be implemented through various configurations that do not depart from the scope of the disclosure. For example, the technique of the present disclosure can be implemented through the following configurations. The technical features of the exemplary embodiments described above that correspond to the technical features of the configurations described below may be appropriately replaced or combined in order to overcome a portion or all of the issues that the technique of the present disclosure is to overcome, or in order to achieve a portion or all of the effects that the technique of the present disclosure is to provide. Furthermore, the technical features that are not described in the present specification as an essential feature may be omitted as appropriate.

(1) A first configuration is provided as a liquid container. A liquid container of such a configuration includes a liquid storing chamber in which a liquid is stored, a first member that includes a cylindrical first side wall that surrounds at least a portion of the liquid storing chamber, a first opening surrounded by a first end portion of the first side wall, and a second opening surrounded by a second end portion of the first side wall, a liquid outlet member that includes an outlet through which the liquid flows out, the liquid outlet member being attached to the first opening, and a second member joined to the first member, the second member sealing the liquid storing chamber from a second opening side. When viewed in a central axis direction of the first member, a joint between the first member and the second member is formed outside an area surrounded by a boundary between the first member and the second member in the liquid storing chamber.

In the liquid container of such a configuration, since the joint is provided at a position where access thereto with a tool or a device used in joining is facilitated, various appropriate joining techniques can be used in joining the first member and the second member to each other. Furthermore, the joining between the first member and the second member is facilitated and the sealing property of the liquid storing chamber defined by the first member and the second member can be improved easily.

(2) In the liquid container having the configuration described above, the second member may include a bottom wall that opposes the second opening of the first member, and a cylindrical second side wall that extends from the bottom wall towards a first member side and that surrounds at least a portion of the liquid storing chamber.

With the liquid container of such a configuration, the liquid storing chamber can be easily defined by the first side wall of the first member, the second side wall of the second member, and the bottom wall.

(3) In the liquid container having the configuration described above, the first member may include a peripheral protrusion that is provided at a periphery of the second opening and that extends outwards from the first side wall in a radial direction of the first member, and the joint may be a portion in which the peripheral protrusion and the second member are joined to each other.

In the liquid container of such a configuration, since the peripheral protrusion in which the joint is formed extends in the radial direction, welding between the first member and the second member is facilitated further.

(4) In the liquid container having the configuration described above, the second side wall may be inserted in the second opening and may be in contact with an entire circumference of an internal circumferential surface of the first side wall, the bottom wall may include an extension portion that extends in a radial direction of the second side wall and that opposes an entire circumference of an end surface of the first side wall that surrounds the second opening, and the joint may be a portion in which the extension portion and the end surface of the first side wall are joined to each other.

In the liquid container of such a configuration, welding of the bottom wall to the first member is facilitated.

(5) In the liquid container having the configuration described above, the second side wall may be inserted in the second opening and may be in contact with an entire circumference of an internal circumferential surface of the first side wall, the first member may further include a cylindrical first-member-side external circumferential wall portion that surrounds an external circumference of the first side wall, and the joint may be a portion in which an end portion of the first-member-side external circumferential wall portion on a second member side and the second member are joined to each other.

In the liquid container of such a configuration, the sealing property of the liquid storing chamber can be improved by contact between the external circumferential surface of the second side wall and the internal circumferential surface of the first side wall.

Furthermore, the first side wall and the second side wall can be protected with the first-member-side external circumferential wall portion. Moreover, the first member and the second member can be joined to each other easily at the end portion of the first-member-side external circumferential wall portion.

(6) In the liquid container having the configuration described above, a protrusion that protrudes outwards in a radial direction of the first-member-side external circumferential wall portion may be provided at the end portion of the first-member-side external circumferential wall portion on the second member side, the bottom wall may include an extension portion that extends in a radial direction of the second side wall from an external circumference of the second side wall and that is in contact with the protrusion, and the joint may be a portion in which the protrusion and the extension portion are joined to each other.

In the liquid container of such a configuration, since the protrusion of the first-member-side external circumferential wall portion and the extension portion of the second side wall, in which the joint is formed, protrude in the radial direction, joining of the first member and the second member to each other is further facilitated.

(7) In the liquid container having the configuration described above, the joint may include a heat caulking portion that joins the protrusion and the extension portion to each other by heat caulking.

In the liquid container of such a configuration, the first member and the second member can be easily joined to each other by heat caulking.

(8) In the liquid container having the configuration described above, the second side wall may be inserted in the second opening and may be in contact with an entire circumference of an internal circumferential surface of the first side wall, the first member may include a peripheral protrusion that extends outwards from the first side wall in a radial direction of the first member and that surrounds the first side wall, the second member may further include a cylindrical second-member-side external circumferential wall portion that extends from the bottom wall towards the first member side and that surrounds an external circumference of the second side wall, and the joint may be a portion in which an end portion of the second-member-side external circumferential wall portion on the first member side and peripheral protrusion are joined to each other.

In the liquid container of such a configuration, the sealing property of the liquid storing chamber can be improved by contact between the external circumferential surface of the second side wall and the internal circumferential surface of the first side wall.

Furthermore, the first side wall and the second side wall can be protected with the second-member-side external circumferential wall portion. Moreover, the first member and the second member can be joined to each other easily at the end portion of the second-member-side external circumferential wall portion.

(9) In the liquid container having the configuration described above, a protruding edge portion that protrudes outwards in a radial direction of the second-member-side external circumferential wall portion and that opposes the peripheral protrusion of the first member may be provided at the end portion of the second-member-side external circumferential wall portion on the first member side, and the joint may be a portion in which the protruding edge portion and the peripheral protrusion are joined to each other.

In the liquid container of such a configuration, since the peripheral protrusion of the first member and the protruding edge portion of the second-member-side external circumferential wall portion, in which the joint is formed, protrude in the radial direction, joining of the first member and the second member to each other is further facilitated.

(10) In the liquid container having the configuration described above, the joint may include a heat caulking portion that joins the protruding edge portion and the peripheral protrusion to each other by heat caulking.

In the liquid container of such a configuration, the first member and the second member can be easily joined to each other by heat caulking.

(11) In the liquid container having the configuration described above, the second side wall may be inserted in the second opening and may be in contact with an entire circumference of an internal circumferential surface of the first side wall, the second member may further include a cylindrical second-member-side external circumferential wall portion that extends from the bottom wall towards the first member side and that surrounds an external circumference of the first side wall, and the joint may include a screw portion provided at a portion in which an internal circumferential surface of the second-member-side external circumferential wall portion and an external circumferential surface of the first side wall oppose each other.

In the liquid container of such a configuration, the first member and the second member can be joined to each other easily with the screw structure. Furthermore, the sealing property of the liquid storing chamber can be improved by contact between the external circumferential surface of the second side wall and the internal circumferential surface of the first side wall.

(12) In the liquid container having the configuration described above, the second side wall may be in contact with an entire circumference of an internal circumferential surface of the first side wall, the first member may further include a cylindrical first-member-side external circumferential wall portion that surrounds an external circumference of the first side wall and that extends towards the second member, the second member may further include a cylindrical second-member-side external circumferential wall portion that extends from the bottom wall towards the first member side and that surrounds an external circumference of the first-member-side external circumferential wall portion, and the joint may include a screw portion provided at a portion in which an internal circumferential surface of the second-member-side external circumferential wall portion and an external circumferential surface of the first-member-side external circumferential wall portion oppose each other.

In the liquid container of such a configuration, the first member and the second member can be joined to each other easily with the screw structure. Furthermore, the sealing property of the liquid storing chamber can be improved by contact between the external circumferential surface of the second side wall and the internal circumferential surface of the first side wall.

Furthermore, the first side wall can be protected with the first-member-side external circumferential wall portion.

### 14. Others

The technique of the present disclosure can be implemented in various configurations other than the liquid container. The technique of the present disclosure can be implemented in configurations such as, for example, a method of manufacturing a liquid container, a structure of a liquid container, a liquid consuming system, a liquid refilling system, and a method of refilling a liquid into a liquid consuming device.

Furthermore, the configuration of the liquid container of the present disclosure can be applied to liquid containers that are used in any liquid ejecting apparatuses that consume a liquid other than ink. For example, the configuration of the liquid container of the present disclosure can be applied to liquid containers that are used in various liquid ejecting apparatuses described below.

(1) An image recording device such as a facsimile machine.
(2) A coloring material ejection device used to manufacture a color filter of an image display device such as a liquid crystal display.
(3) An electrode material ejection device used to form electrodes of organic electroluminescence (EL) displays and surface emitting displays (field emission display or FED).
(4) A liquid ejection device that ejects a liquid containing bio-organic matter to manufacture biochips.
(5) A sample ejection device serving as a precision pipette.
(6) Lubricating oil injection device.
(7) Liquid resin injection device.
(8) A liquid ejection device that ejects lubricant oil in a pinpoint manner to precision instruments such as a watch and a camera.
(9) A liquid ejection device that sprays transparent liquid resin such as ultraviolet curing resin on a substrate in order to form a hemispherical microlens (optical lens) used in optical communication elements and the like.
(10) A liquid ejection device that ejects acid or alkaline etching solution for etching substrates and the like.
(11) A liquid ejection device including a liquid consuming head that ejects any micro amount of droplets other than the above.

Note that the liquid contained in the liquid container of the present disclosure may be any material in liquid phase. Accordingly, the “liquid” in the present disclosure includes a material in a liquid state with high or low viscosity, and materials in a liquid state such as sol, gel water, other inorganic solvents, an organic solvent, a solution, liquid resin, and liquid metal (metallic melt). Furthermore, not just liquid as a state of matter, the liquid includes particles of functional material including a solid body such as pigment or metal particle that is dissolved, dispersed, or mixed in a solvent. Other than the above, a representative example of the liquid includes ink, liquid crystal, and others that have been described in the exemplary embodiments described above. Note that “ink” includes various liquid-form compositions such as a typical aqueous ink, solvent ink, gel ink, and a hot melt ink.

What is claimed is:

1. A liquid container comprising:
a liquid storing chamber in which a liquid is stored;
a first member that includes
a cylindrical first side wall that surrounds at least a portion of the liquid storing chamber,
a first opening surrounded by a first end portion of the first side wall, and
a second opening surrounded by a second end portion of the first side wall;
a liquid outlet member that includes an outlet through which the liquid flows out, the liquid outlet member being attached to the first opening; and
a second member joined to the first member, the second member sealing the liquid storing chamber from a second opening side, wherein
when viewed in a central axis direction of the first member, a joint between the first member and the second member is formed outside an area surrounded by a boundary between the first member and the second member in the liquid storing chamber.

2. The liquid container according to claim 1, wherein
the second member includes
a bottom wall that opposes the second opening of the first member, and
a cylindrical second side wall that extends from the bottom wall towards a first member side and that surrounds at least a portion of the liquid storing chamber.

3. The liquid container according to claim 1, wherein
the first member includes a peripheral protrusion that is provided at a periphery of the second opening and that extends outwards from the first side wall in a radial direction of the first member, and
the joint is a portion in which the peripheral protrusion and the second member are joined to each other.

4. The liquid container according to claim 2, wherein
the second side wall is inserted in the second opening and is in contact with an entire circumference of an internal circumferential surface of the first side wall,
the bottom wall includes an extension portion that extends in a radial direction of the second side wall and that opposes an entire circumference of an end surface of the first side wall that surrounds the second opening, and
the joint is a portion in which the extension portion and the end surface of the first side wall are joined to each other.

5. The liquid container according to claim 2, wherein
the second side wall is inserted in the second opening and is in contact with an entire circumference of an internal circumferential surface of the first side wall,
the first member further includes a cylindrical first-member-side external circumferential wall portion that surrounds an external circumference of the first side wall, and
the joint is a portion in which an end portion of the first-member-side external circumferential wall portion on a second member side and the second member are joined to each other.

6. The liquid container according to claim 5, wherein
a protrusion that protrudes outwards in a radial direction of the first-member-side external circumferential wall portion is provided at the end portion of the first-member-side external circumferential wall portion on the second member side,
the bottom wall includes an extension portion that extends in a radial direction of the second side wall from an external circumference of the second side wall and that is in contact with the protrusion, and
the joint is a portion in which the protrusion and the extension portion are joined to each other.

7. The liquid container according to claim 6, wherein
the joint includes a heat caulking portion that joins the protrusion and the extension portion to each other by heat caulking.

8. The liquid container according to claim 2, wherein
the second side wall is inserted in the second opening and is in contact with an entire circumference of an internal circumferential surface of the first side wall,
the first member includes a peripheral protrusion that extends outwards from the first side wall in a radial direction of the first member and that surrounds the first side wall,
the second member further includes a cylindrical second-member-side external circumferential wall portion that extends from the bottom wall towards the first member side and that surrounds an external circumference of the second side wall, and
the joint is a portion in which an end portion of the second-member-side external circumferential wall portion on the first member side and peripheral protrusion are joined to each other.

9. The liquid container according to claim 8, wherein
a protruding edge portion that protrudes outwards in a radial direction of the second-member-side external circumferential wall portion and that opposes the peripheral protrusion of the first member is provided at the end portion of the second-member-side external circumferential wall portion on the first member side, and
the joint is a portion in which the protruding edge portion and the peripheral protrusion are joined to each other.

10. The liquid container according to claim 9, wherein
the joint includes a heat caulking portion that joins the protruding edge portion and the peripheral protrusion to each other by heat caulking.

11. The liquid container according to claim 2, wherein
the second side wall is inserted in the second opening and is in contact with an entire circumference of an internal circumferential surface of the first side wall,
the second member further includes a cylindrical second-member-side external circumferential wall portion that extends from the bottom wall towards the first member side and that surrounds an external circumference of the first side wall, and
the joint includes a screw portion provided at a portion in which an internal circumferential surface of the second-member-side external circumferential wall portion and an external circumferential surface of the first side wall oppose each other.

12. The liquid container according to claim 2, wherein
the second side wall is in contact with an entire circumference of an internal circumferential surface of the first side wall,
the first member further includes a cylindrical first-member-side external circumferential wall portion that surrounds an external circumference of the first side wall and that extends towards the second member,
the second member further includes a cylindrical second-member-side external circumferential wall portion that extends from the bottom wall towards the first member side and that surrounds an external circumference of the first-member-side external circumferential wall portion, and
the joint includes a screw portion provided at a portion in which an internal circumferential surface of the second-member-side external circumferential wall portion and an external circumferential surface of the first-member-side external circumferential wall portion oppose each other.
